(19) United States
(12) Patent Application Publication
(10) Pub. No.: US 2006/0160607 A1
(43) Pub. Date: Jul. 20, 2006

(54) Game machine and game system

(75) Inventor: Kazuo Okada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/289,278

(22) Filed: Nov. 30, 2005

(30) Foreign Application Priority Data
Dec. 10, 2004 (JP) 2004-358684
Dec. 10, 2004 (JP) 2004-358670

(51) Int. Cl. A63F 13/00

(52) U.S. Cl. 463/21; 463/20; 463/25

(57) ABSTRACT

A game machine and a game system may have a transition probability to a bonus game mode changed by a gamer. In a slot machine according to the present invention, when the gamer mounts a figurine in a figurine mounting unit, the figurine information stored in the figurine is read by an IC chip reader/writer. If the reading of the figurine information is performed by the IC chip reader/writer, a CPU starts counting of a game number. Next, when the game number reaches a predetermined game number, the CPU operating as a probability changer transitions a game mode from a standard game mode to a high-probability game mode, so that the transition probability is changed from a standard transition probability P0 to a high transition probability P1 (>P0).

This application is based on and claims the benefit of priority from Japanese Patent Applications No. 2004-358670 and No. 2004-358684, filed on 10 Dec. 2004 the contents of which are incorporated herein by reference.

### BACKGROUND OF THE INVENTION

1. Technical Field

The present invention relates to game machine such as a slot machine and a game player and to a game system.

2. Related Art

Conventionally, there have been a game machines (hereinafter, referred to as slot machines) for producing plural columns of plural designs or displaying plural columns of changeable display images for plural designs, determining winning in a game and a state (winning state) in a case of winning according to a combination of the designs in the columns at the time of exchange the changeable display stopped, and paying a game medium (hereinafter, referred to as a coin) used for the game such as a medal or a hard currency. In this type of game machine, there is a game machine having a base game mode for performing a base game, and a bonus game mode for performing a bonus game profitable for a specially favored gamer according to fulfilling of a played condition such as a stopped display of specific designs. For example, in Patent Document 1, a game machine having a plurality of bonus games and determining one of the bonus games at random selected by a lottery is disclosed.

Patent Document 1: Japanese Translation Patent Publication No. 2002-537874

Patent Document 2: Japanese Unexamined Patent Application Publication No. 2004-216038

Patent Document 3: Japanese Unexamined Patent Application Publication No. 2002-325972

In general, although a player of a game machine plays the game in desire for a larger amount of coin payment, in the conventional game machine as disclosed in Patent Document 1, a transition probability from a base game mode to a bonus game mode is fixed by a game machine maker or a game machine installation hall. In other words, the gamer must play the game according to only the transition probability entirely controlled by the game machine maker or the game machine installation hall. Many gamers are unsatisfied or displeased with these situations. Therefore, there has been a need for a novel game machine in which the gamers can change the transition probability to the bonus game mode independently by manipulation by the gamers.

In addition, game machines for performing a game process by reading information from a figurine storing game data and using the read information are disclosed in Patent Document 2 and Patent Document 3.

### SUMMARY OF THE INVENTION

The present invention was made in order to solve the aforementioned problems, and an advantage of the present invention is to provide a game machine or a game system capable of changing a transition probability to a bonus game mode by a gamer.

According to an aspect of the present invention, there is provided a game machine having a base game mode and a bonus game mode as game modes, including: game mode controller for transitioning the game mode from base game mode into the bonus game mode by using a first transition probability which is a transition probability from the base game mode into the bonus game mode; reader for reading game associated information from a game item storing the game associated information on the game; counter for starting counting of a game number if the game associated information is read by the reader; and probability changer for changing the first transition probability used in the game mode controller to a second transition probability which is higher than the first transition probability, if the game number counted by the counter reaches a predetermined game number.

### DETAILED DESCRIPTION OF THE INVENTION

In the game machine, a gamer performs a predetermined reading operation by using the game item, so that the game associated information stored in the game item is read by the reader. If the reading of the game associated information is performed by the reader, the counter starts counting of the game number. Next, the count of the game number by the counter reaches a predetermined game number, the probability changer changes from the first transition probability used in the game mode controller to the second transition probability. Since the second transition probability is higher than the first transition probability, in the game machine according to the present invention, the gamer plays the game by using the game item, so that the game can be played in a high transition probability from the base game mode to the bonus game mode.

It is preferable that the game associated information stored in the game item include bonus game number information representing a game number for changing from the first transition probability to the second transition probability, and the probability changer use the game number represented by the bonus game number information included in the game associated information read by the reader as the predetermined game number at the time of changing from the first transition probability to the second transition probability.

It is preferable that the game machine further include a number storage unit for storing game number information, wherein the probability changer uses the number represented by the game number information stored in the number storage unit as the predetermined game number at the time of changing from the first transition probability to the second transition probability.

It is preferable that the number storage unit store a plural game number information and the game associated information on the game in association with each other, and the probability changer use a game number represented by the game number information stored in the number storage unit in association with the game associated information read by the reader as the predetermined game number at the time of changing from the first transition probability to the second transition probability.

It is preferable that the game associated information stored in the game item include specific probability information representing a transition probability to the first transition probability, and the probability changer uses a probability represented by the specific probability information included in the game associated information read by the reader as the second transition probability.

It is preferable that the game machine further include a probability storage unit storing a plurality of different probability information, wherein the game mode controller uses a probability represented by one of the plurality of probability information stored in the probability storage unit as the first transition probability, and in which the probability changer uses a probability represented by one of the plurality of probability information stored in the probability storage unit as the second transition probability.

It is preferable that the probability storage unit stores the probability information and the game associated information on the game in association with each other, and the probability changer uses a probability represented by the probability information stored in the probability storage unit associated with the game associated information read by the reader as the second transition probability.

According to another aspect of the present invention, there is provided a game system having a game machine having a base game mode and a bonus game mode as game modes and a game server communicationably connected to the game machine, the game machine include:

game mode controller for transitioning the game mode from base game mode into the bonus game mode by using a first transition probability which is a transition probability from the base game mode into the bonus game mode; reader for reading game associated information from a game item storing the game associated information on the game; communication device for transmitting the game associated information read by the reader to the game server and receiving game number information transmitted from the game server, if the game associated information is read by the reader; counter for starting counting of a game number if the game associated information is read by the reader; and probability changer for changing the first transition probability used in the game mode controller to a second transition probability which is higher than the first transition probability, if the game number counted by the counter reaches the predetermined game number represented by the game number information received by the communication device, and in which the game server include: a storage unit for storing the game associated information on the game item and the game number information in association with each other; receiver for receiving the game associated information transmitted from the game machine; information extractor for extracting the game number information stored in the storage unit in association with the game associated information received by the receiver; and transmitter for transmitting the game number information extracted by the information extractor to the game machine.

In the game system, a gamer performs a predetermined reading operation by using the game item, so that the game associated information stored in the game item is read by the reader of the game machine. If the reading of the game associated information is performed by the reader, the communication device of the game machine transmits the game associated information to the game server, and at the same time, receives the game number information associated with the game associated information from the game server. In addition, if the reading of the game associated information is performed by the reader, the counter starts counting of the game number of the game machine. Next, the count of the game number by the counter reaches a predetermined game number represented by the game number information, the probability changer changes the first transition probability used in the game mode controller to the second transition probability. Since the second transition probability is higher than the first transition probability, in the game system according to the present invention, the gamer plays the game with the game machine by using the game item, so that the game can be played in a high transition probability from the base game mode to the bonus game mode.

According to still another aspect of the present invention, there is provided a game machine having a base game mode and a bonus game mode as game modes, comprising: game mode controller for transitioning the game mode from base game mode into the bonus game mode by using a first transition probability which is a transition probability from the base game mode into the bonus game mode; reader for reading game associated information from a game item storing the game associated information on the game; time counter for starting counting of a game time if the game associated information is read by the reader; and probability changer for changing the first transition probability used in the game mode controller to a second transition probability which is higher than the first transition probability, if the game time counted by the time counter reaches the predetermined time.

In the game machine, a gamer performs a predetermined reading operation by using the game item, so that the game associated information stored in the game item is read by the reader. If the reading of the game associated information is performed by the reader, the time counter starts counting of the game time. Next, if the game time counted by the time counter reaches a predetermined time, the probability changer changes from the first transition probability used in the game mode controller to the second transition probability. Since the second transition probability is higher than the first transition probability, in the game machine according to the present invention, the gamer plays the game by using the game item, so that the game can be played in a high transition probability from the base game mode to the bonus game mode.

It is preferable that the game associated information stored in the game item include bonus game time information representing a game time for changing from the first transition probability to the second transition probability, and that the probability changer use the game time represented by the bonus game time information included in the game associated information read by the reader as the predetermined time at the time of changing from the first transition probability to the second transition probability.

It is preferable that the game machine further include a time storage unit for storing game time information, in which the probability changer uses the time represented by the game time information stored in the time storage unit as the predetermined time at the time of changing from the first transition probability to the second transition probability.

It is preferable that the time storage unit store a plurality of the game time information and the game associated information on the game in association with each other, and that the probability changer use a game time represented by the game time information stored in the time storage unit in association with the game associated information read by the reader as the predetermined time at the time of changing from the first transition probability to the second transition probability.

According to another aspect of the present invention, there is provided a game machine having a base game mode and a bonus game mode as game modes, include: game mode controller for transitioning the game mode from base game mode into the bonus game mode by using a first transition probability which is a transition probability from the base game mode into the bonus game mode; reader for reading game associated information from a game item storing the game associated information on the game; time output device for outputting information on a current time; and probability changer for changing the first transition probability used in the game mode controller to a second transition probability which is higher than the first transition probability, if a time represented by the time information output by the time output device as the time that the game associated information is read by the reader satisfies a predetermined time condition.

In the game machine, a gamer performs a predetermined reading operation by using the game item, so that the game associated information stored in the game item is read by the reader. Next, at the time that the reading of the game associated information is performed by the reader, if the time represented by the time information output from the time output device satisfies the predetermined time condition, the probability changer changes from the first transition probability used in the game mode controller to the second transition probability. Since the second transition probability is higher than the first transition probability, in the game machine according to the present invention, the gamer plays the game by using the game item, so that the game can be played in a high transition probability from the base game mode to the Bonus game mode.

It is preferable that the game associated information stored in the game item include bonus game time information representing a time condition for changing from the first transition probability to the second transition probability, and that the probability changer use the time condition represented by the bonus game time information included in the game associated information read by the reader as the predetermined time condition at the time of changing from the first transition probability to the second transition probability.

It is preferable that the game machine further include a time condition storage unit for storing time condition information, in which the probability changer uses the time condition represented by the time condition information stored in the time condition storage unit as the predetermined time condition at the time of changing from the first transition probability to the second transition probability.

It is preferable that the time condition storage unit store a plurality of the time condition information and the game associated information on the game in association with each other, and that the probability changer use a time condition represented by the time condition information stored in the time condition storage unit in association with the game associated information read by the reader as the predetermined time condition at the time of changing from the first transition probability to the second transition probability.

It is preferable that the game associated information stored in the game item include specific probability information representing a transition probability to the first transition probability, and that the probability changer use a probability represented by the specific probability information included in the game associated information read by the reader as the second transition probability.

It is preferable that the game machine further include a probability storage unit storing a plurality of different probability information, in which the game mode controller uses a probability represented by one of the plurality of probability information stored in the probability storage unit as the first transition probability, and in which the probability changer uses a probability represented by one of the plurality of probability information stored in the probability storage unit as the second transition probability.

It is preferable that the probability storage unit store the probability information and the game associated information on the game in association with each other, and that the probability changer use a probability represented by the probability information stored in the probability storage unit associated with the game associated information read by the reader as the second transition probability.

According to another aspect of the present invention, there is provided a game system having a game machine having a base game mode and a bonus game mode as game modes and a game server communicationably connected to the game machine, in which the game machine include: game mode controller for transitioning the game mode from base game mode into the bonus game mode by using a first transition probability which is a transition probability from the base game mode into the bonus game mode; reader for reading game associated information from a game item storing the game associated information on the game; communication device for transmitting the game associated information read by the reader to the game server and receiving game time information transmitted from the game server, if the game associated information is read by the reader; time counter for counting a game time if the game associated information is read by the reader; and probability changer for changing the first transition probability used in the game mode controller to a second transition probability which is higher than the first transition probability, if the game time reaches a predetermined time represented by the game time information received by the communication device, and in which the game server include: a storage unit for storing the game associated information on the game item and the game time information in association with each other; receiver for receiving the game associated information transmitted from the game machine; information extractor for extracting the game time information stored in the storage unit in association with the game associated information received by the receiver; and transmitter for transmitting the game time information extracted by the information extractor to the game machine.

In the game system, a gamer performs a predetermined reading operation by using the game item, so that the game associated information stored in the game item is read by the reader of the game machine. If the reading of the game associated information is performed by the reader, the communication device of the game machine transmits the game associated information to the game server, and at the same time, receives the game time information associated with the game associated information from the game server. In addition, if the reading of the game associated information is performed by the reader, the time counter starts counting of the game time of the game machine. Next, the game time counted by the time counter reaches a predetermined time represented by the game time information, the probability changer changes the first transition probability used in the game mode controller to the second transition probability. Sine the second transition probability is higher than the first transition probability, in the game system according to the present invention, the gamer plays the game with the game machine by using the game item, so that the game can be played in a high transition probability from the base game mode to the bonus game mode.

According to another aspect of the present invention, there is provided a game system having a game machine having a base game mode and a bonus game mode as game modes and a game server communicationably connected to the game machine, in which the game machine include: game mode controller for transitioning the game mode from base game mode into the bonus game mode by using a first transition probability which is a transition probability from the base game mode into the bonus game mode; reader for reading game associated information from a game item storing the game associated information on the game; communication device for transmitting the game associated information read by the reader to the game server and receiving time condition information transmitted from the game server, if the game associated information is read by the reader; time output device for outputting information on a current time; and probability changer for changing the first transition probability used in the game mode controller to a second transition probability which is higher than the first transition probability, if a time represented by the time information output by the time output device as the time that the game associated information is read by the reader satisfies a predetermined time condition represented by the time condition information received by the communication device, and in which the game server includes: a storage unit for storing the game associated information on the game item and the time condition information in association with each other; receiver for receiving the game associated information transmitted from the game machine; information extractor for extracting the time condition information stored in the storage unit in association with the game associated information received by the receiver; and a transmitter for transmitting the time condition information extracted by the information extractor to the game machine.

In the game system, a gamer performs a predetermined reading operation by using the game item, so that the game associated information stored in the game item is read by the reader of the game machine. If the reading of the game associated information is performed by the reader, the communication device of the game machine transmits the game associated information to the game server, and at the same time, receives the time condition information associated with the game associated information from the game server. In addition, at the time that the reading of the game associated information is performed by the reader, if the time represented by the time information output from the time output device satisfies the predetermined time condition represented by the time condition information, the probability changer changes from the first transition probability used in the game mode controller to the second transition probability. Sine the second transition probability is higher than the first transition probability, in the game system according to the present invention, the gamer plays the game with the game machine by using the game item, so that the game can be played in a high transition probability from the base game mode to the bonus game mode.

According to the present invention, there is provided a game machine and a game system in which a gamer can change a transition probability to a bonus game mode.

### BRIEF DESCRIPTION OF THE DRAWINGS

The invention will be described with reference to the accompanying drawings, in which like numbers reference like elements.

FIG. 1 is a perspective view showing the overall construction of a slot machine according to a first embodiment of a game machine of the present invention;

FIG. 2 is a front view showing a main display of the slot machine shown in FIG. 1;

FIG. 3 is a perspective view showing a construction of reels;

FIG. 4 is a perspective view showing one of the reels shown in FIG. 3;

FIG. 5 is a perspective view showing a schematic construction of a liquid crystal display apparatus as seen from a rear side of a housing;

FIG. 6 is a partial exploded perspective view of a liquid crystal display apparatus;

FIG. 7 is a block diagram mainly showing an internal construction of the slot machine according to the first embodiment;

FIG. 8 is a block diagram showing an example of an internal construction of an image control circuit;

FIG. 9 is a partial cutaway front view of a figurine;

FIG. 10 is a flowchart showing a sequence of operations from the starting to the ending of a slot game;

FIG. 11 is a flowchart showing a sequence of operations of a figurine information reading receiving process;

FIG. 12 is a flowchart showing a sequence of operations of no figurine game process;

FIG. 13 is a flowchart showing a sequence of operations of figurine game process;

FIG. 14 is a flowchart showing a sequence of operation of a standard game process and a high-probability game process;

FIG. 15A is a timing chart showing a change of transition probability in no figurine game mode according to the first embodiment, and FIG. 15B is a timing chart showing a change of transition probability in figurine game mode according to the first embodiment;

FIG. 16 is a view showing another type of a timing chart;

FIG. 17 is a block diagram mainly showing an internal construction of the slot machine according to a second embodiment;

FIG. 18 is a block diagram mainly showing an internal construction of the slot machine according to a third embodiment;

FIG. 19A is a view showing a data construction of a game number database, and FIG. 19B is a view showing a data construction of a transition probability database;

FIG. 20 is a view showing a data construction of another type of a game number database;

FIG. 21 is a view showing another type of a timing chart;

FIG. 22 is a perspective view showing an overall construction of a slot machine according to a fourth embodiment of a game machine of the present invention;

FIG. 23 is a block diagram mainly showing an internal construction of the slot machine according to the fourth embodiment;

FIG. 24 is a block diagram showing a schematic construction of a game system according to the present invention;

FIG. 25 is a block diagram mainly showing an internal construction of the slot machine according to a sixth embodiment;

FIG. 26 is a flowchart showing a sequence of operations from the starting to the ending of a slot game;

FIG. 27 is a flowchart showing a sequence of operations of a figurine information reading receiving process;

FIG. 28 is a flowchart showing a sequence of operations of no figurine game process;

FIG. 29 is a flowchart showing a sequence of operations of no figurine game process;

FIG. 30 is a flowchart showing a sequence of operation of a standard game process and a high-probability game process;

FIG. 31A is a timing chart showing a change of transition probability in no figurine game mode according to the sixth embodiment, and FIG. 31B is a timing chart showing a change of transition probability in figurine game mode according to the sixth embodiment;

FIG. 32 is a view showing another type of a timing chart;

FIG. 33 is a block diagram mainly showing an internal construction of the slot machine according to a seventh embodiment;

FIG. 34 is a block diagram mainly showing an internal construction of the slot machine according to an eighth embodiment;

FIG. 35A is a view showing a data construction of a game time database, and FIG. 35B is a view showing a data construction of a transition probability database;

FIG. 36 is a view showing a data construction of another type of a game time database;

FIG. 37 is a view showing another type of a timing chart;

FIG. 38 is a perspective view showing an overall construction of a slot machine according to a ninth embodiment of a game machine of the present invention;

FIG. 39 is a block diagram mainly showing an internal construction of the slot machine according to the ninth embodiment;

FIG. 40 is a block diagram showing a schematic construction of a game system according to the present invention;

FIG. 41 is a block diagram mainly showing an internal construction of the slot machine according to an eleventh embodiment;

FIG. 42 is a flowchart showing a sequence of operation of no figurine game process in the slot machine shown in FIG. 41;

FIG. 43 is a flowchart showing a sequence of operations of a standard game process and a high-probability game process in the slot machine shown in FIG. 41;

FIG. 44 is a timing chart showing a change of transition probability according to the eleventh embodiment;

FIG. 45 is a block diagram mainly showing an internal construction of a slot machine according to a twelfth embodiment;

FIG. 46 is a block diagram mainly showing an internal construction of a slot machine according to a thirteenth embodiment;

FIG. 47A is a view showing a data construction of a time condition database, and FIG. 47B is a view showing a data construction of a transition probability database;

FIG. 48 is a view showing another type of a timing chart;

FIG. 49 is a block diagram mainly showing an internal construction of the slot machine according to a fourteenth embodiment; and

FIG. 50 is a block diagram showing a schematic construction of a game system according to the present invention.

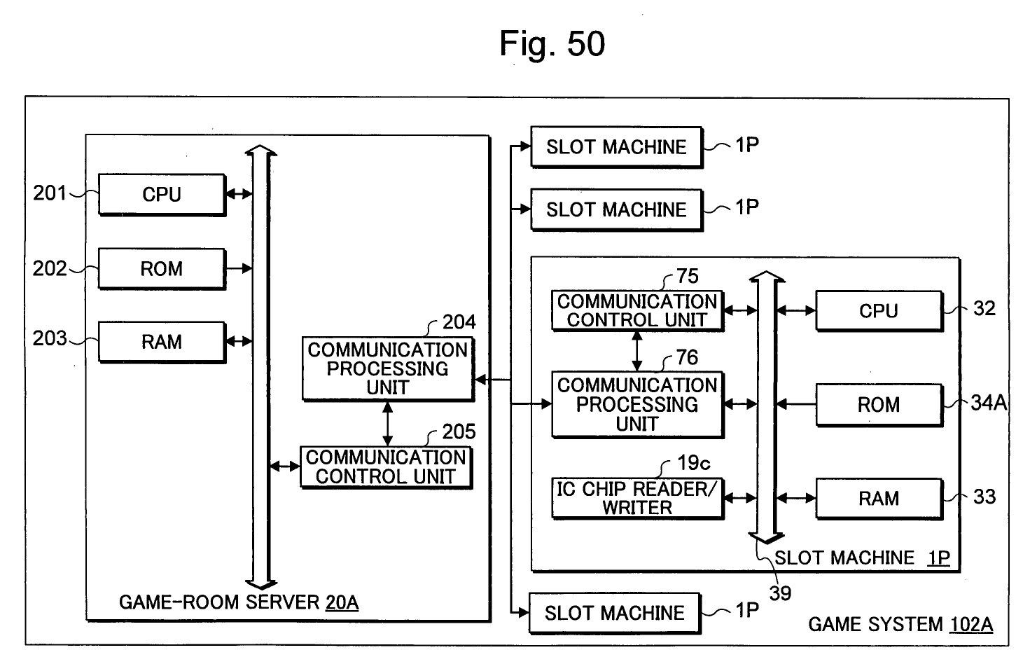

### DESCRIPTION OF THE EMBODIMENTS

Best modes for playing a game machine and a game system according to the present invention will be described in detail with reference to the accompanying drawings. The same or equivalent components are indicted with the same reference numerals, and description on the redundant portions will be omitted.

### First Embodiment

A slot machine 1A according to a first embodiment of the present invention includes changeable display device for performing changing of display of a plural designs and is constructed to perform a changing display game (hereinafter, sometimes referred as a “slot game”) by using the plurality of changeable displayed designs. The slot machine 1A has a base game mode for performing a base game which can start under a condition in which a predetermined number of coins (game medium) are inserted or a credit card is used and a bonus game mode for performing a bonus game which starts under a predetermined condition after the base game. The slot machine 1A is a coin insert type game machine, and a changeable display game performed as the base game starts by the game inserting the coins or using the credit card. On the other hand, a three-times free game performed as the bonus game is a game in which later-described reels automatically rotate without insertion of coins and stop after an elapse of a predetermined time and coin payment is performed according to a combination of stopped designs, and the game contents thereof are further profitable to the gamer in comparison to the base game. Now, a construction of the slot machine 1A will be described. Overall Construction of Slot Machine

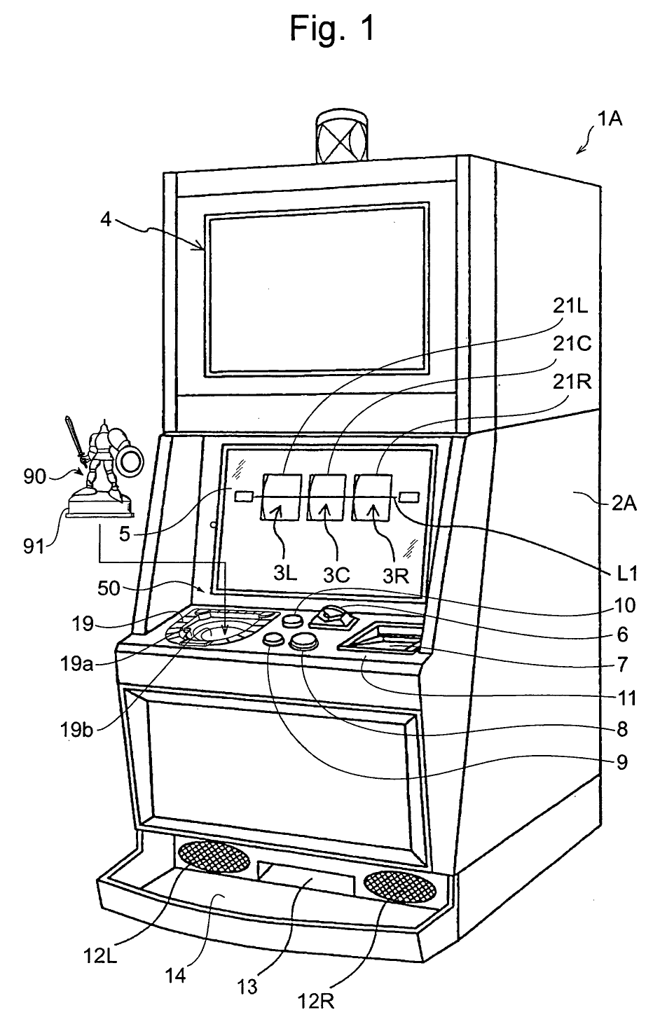

FIG. 1 is a perspective view showing an overall construction of the slot machine 1A. The slot machine 1A includes a sub display 4 and a main display 5 in this order from the top portion of the front side of a housing 2A. The main display 5 is disposed substantially at a center of the housing 2A between the top and bottom portions thereof, and a horizontal column of three mechanical reels 3L, 3C, and 3R corresponding to the main display 5 are pivotably disposed in an inner portion of the housing 2A.

The reels 3L, 3C, and 3R can be externally viewed through later-described designs display regions 21L, 21C, and 21R of the main display 5. In each of the reels 3L, 3C, and 3R, as described later in detail, a design sequence (not shown) having plural types of designs is drawn on a circumferential surface thereof, changeable display device is pivotably provided to variably display the designs, and each of the reels rotates in a predetermined speed, for example, 80 rpm.

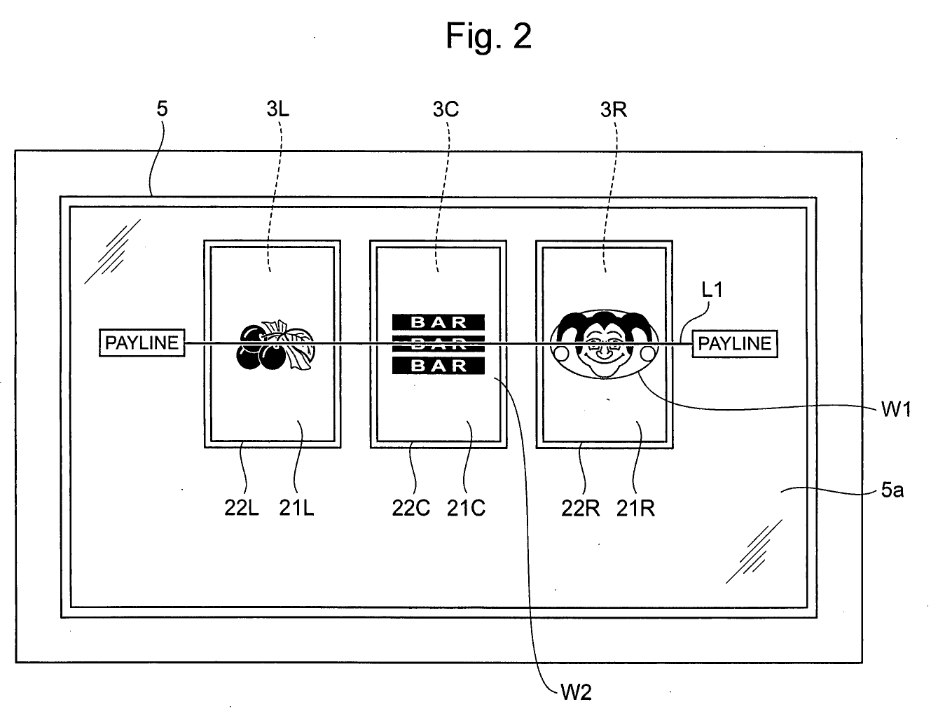

One winning line extending in a horizontal direction L1 is disposed in the design display regions 21L, 21C, and 21R corresponding to the reels 3L, 3C, and 3R, as shown in FIG. 2. In addition to the winning line L1, although not shown, different winning lines may be disposed at upper and lower portions, and two winning lines may be diagonally disposed. In a case in which plural winning lines are disposed, the number of winning lines may be changed according to the number of inserted coins. In this case, each of the winning lines becomes effective according to the number of inserted coins and operations of later-described BET switches 9 and 10. The winning line which becomes effective is called an effective line or a pay line. For example, if the gamer inserts one coin into a later-described coin insertion slot 6, only the central winning line L1 becomes the effective line, if the gamer inserts two coins, the upper or lower winning line becomes effective in addition to the winning line L1, and if the gamer inserts three coins, all the wining lines become effective lines. In addition, although the designs stop in only the winning line L1 in FIG. 2 for the convenience of understanding, three designs vertically aligned are generally displayed on each of the design display regions 21L, 21C, and 21R.

In addition, a substantially horizontal manipulation panel 11 is disposed at a lower side of the main display 5 of the slot machine 1A. The manipulation panel 11 includes a figurine mounting unit 19, a coin insertion slot 6, a paper-money insertion opening 7, a spin switch 8, a 1-BET switch 9, and a maximum BET switch 10.

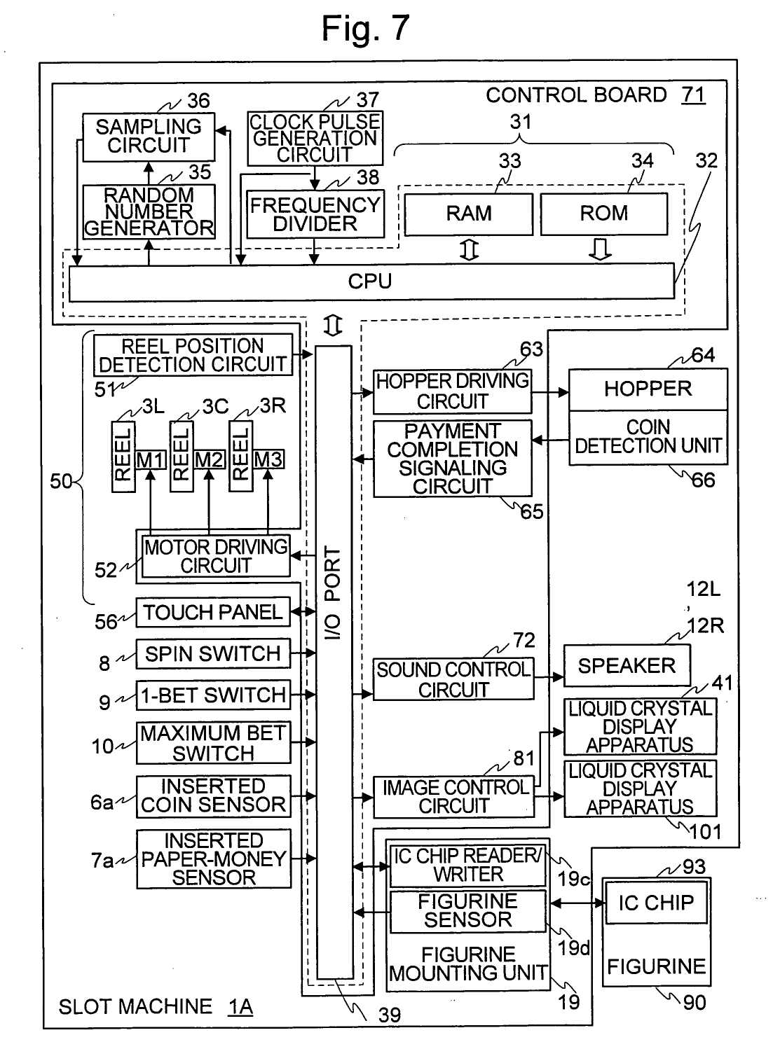

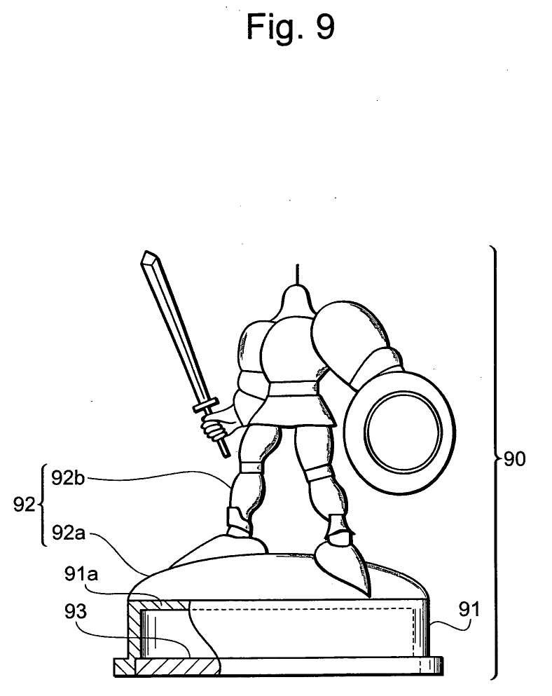

The figurine mounting unit 19 includes a stand mounting unit 19a fixed on a surface of the manipulation panel 11 and a determination unit 19b. The stand mounting unit 19a has a recess corresponding to a shape of the circular disc shaped stand member 91 of a later-described figurine 90 (see FIG. 9) in an inner side of the stand mounting unit, and the stand member 91 is engaged into the recess. The determination unit 19b is disposed in the recess of the stand mounting unit 19a and includes an IC chip reader/writer 19c (see FIG. 7) and a figurine sensor 19d (see FIG. 7). The IC chip reader/writer 19c and the figurine sensor 19d are connected to CPU 32 through an I/O port 39. The IC chip reader/writer 19c reads out information (game associated information in the present invention and, hereinafter, referred to as figurine information) written in the figurine 90 from an IC chip 93 built in the stand member 91 of the mounted figurine 90, inputs the information to the CPU 32, and writes predetermined information in the IC chip 93 in response to a command from the CPU 32. The IC chip reader/writer 19c corresponds to reader in the present invention. In addition, figurine sensor 19d (see FIG. 7) detects the mounting of the figurine 90 in the stand mounting unit 19a (the setting of the figurine) and inputs the detection information representing the detection result to the CPU 32.

The figurine sensor 19d (see FIG. 7) may be various types of sensors such as a magnetic sensor and a mechanical sensor as well as an optical sensor such as a transparency type sensor, a reflection type sensor, and a pressure sensor. In addition, although not shown, the figurine mounting unit 19 has LEDs, so that light can be illuminated on the figurine with the LEDs during a later-described reading operation of the figurine 90.

The coin insertion slot 6 is an insertion slot through which the gamer inserts coins in order to place a bet in the game in the present invention and includes an inserted coin sensor 6a (see FIG. 7) for outputting a signal representing insertion.

In addition, the paper-money insertion opening 7 is an insertion opening through which the gamer inserts paper money and includes a inserted paper-money sensor 7a (see FIG. 7) for outputting a signal representing paper-money insertion. The spin switch 9 starts changeable display of designs due to rotation of the reels 3L, 3C, and 3R in the design display regions 21L, 21C, and 21R, and in other words, is provided in order for the gamer to perform an operation of starting the game. The 1-BET switch 9 is provided in order to perform setting for making a bet of one coin with a one-time operation. The maximum BET switch 10 is provided in order to perform setting for making a bet of maximum number of coins for one game with one time operation.

In addition, at a bottom portion of the housing 2A of the slot machine 1A, a coin pay-out opening 13 and a coin accommodating portion 14 for accommodating the paid coins are provided. In addition, speakers 12L and 12R are disposed at left and right sides of the coin pay-out opening 13, respectively.

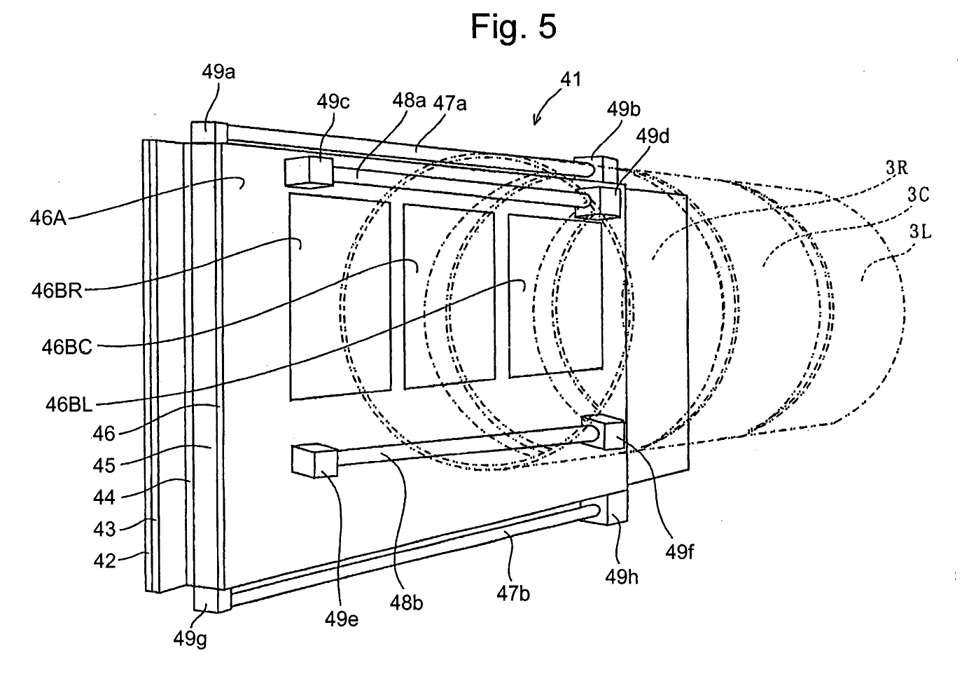

As shown in FIG. 2, the main display 5 includes the design display regions 21L, 21C, and 21R, window frame display regions 22L, 22C, and 22R, and active display regions 5a. The displayed contents of the main display 5 change according to changeable display modes and stop modes of the reels 3L, 3C, and 3R and operational contents of a later-described liquid crystal display apparatus 41 (see FIG. 5). In addition, the main display 5 includes a BET number display portion, a pay-out display portion, a credit display portion, or the like, but these are not shown in FIG. 2.

The design display regions 21L, 21C, and 21R are provided corresponding to the reels 3L, 3C, and 3R in order to visibly display the designs on the reels 3L, 3C, and 3R. In addition, in a case where the reels 3L, 3C, and 3R corresponding to the design display regions 21L, 21C, and 21R are in a rotation state and in a stop state, transparency display is performed in order for the gamer to see the designs on the scrolling reels 3L, 3C, and 3R, and still image display or moving picture display, that is, for example, designs, characters (letters), figurines, symbols, or characters is not performed.

The window frame display regions 22L, 22C, and 22R are disposed to surround the design display regions 21L, 21C, and 21R and have a function as a display window for the designs drawn on the reels 3L, 3C, and 3R.

In addition, in the active display regions 5a, an image for a later-described special lottery game is displayed. In addition, in the active display regions 5a, active for promoting the pleasure of game or information for performing game profitably is displayed.

In the sub-display 4, displayed contents thereof change according to operational contents of the later-described liquid crystal display apparatus 101.

Construction of Reels

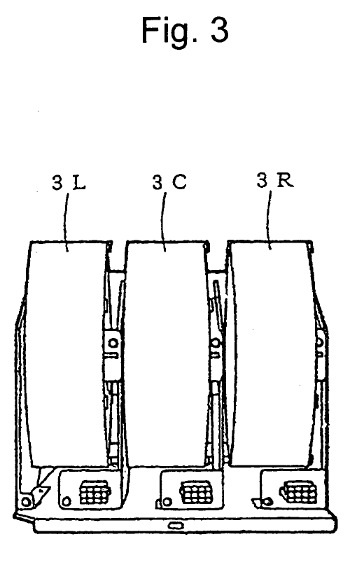

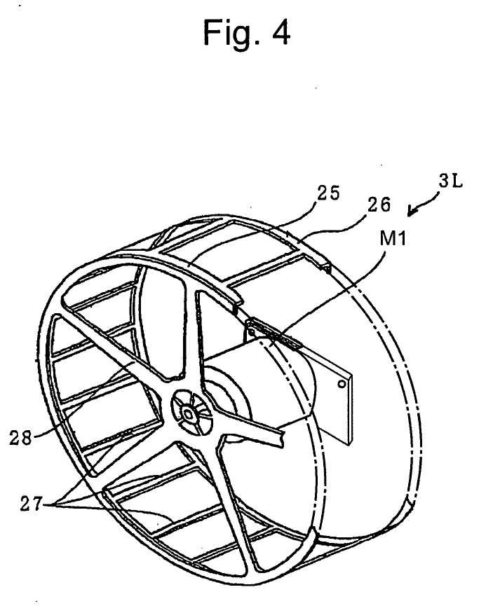

As shown in FIG. 3, the reels 3L, 3C, and 3R are disposed in a horizontal column and pivotably rotate, and all the reels have the same construction. As shown in FIG. 4, the reel 3L is provided with a cylindrical frame in which two circular frames 25 and 36 having the same shape are disposed in an interval and the two circular frames 25 and 26 are connected to each other with a plurality of connection members 27. In addition, as shown in FIG. 4, the reel 3L has a transmission member 28 for transmitting a driving force for a stepping motor M1 (see FIG. 7) disposed at a center of the cylindrical frame to the circular frames 25 and 26, and a reel sheet (not shown) for covering the connection member 27 is attached at a side surface portion. A plurality of designs is drawn on the reel sheet. In addition, although not shown, in each of the reels 3L, 3C, and 3R, LED receiving circuit boards and LED lamps may be disposed at a rear side of three vertical columns of designs (nine designs in total) displayed in the design display regions 21L, 21C, and 21R when the reels stop. By doing so, white light can be illuminated on the main display 5 from the rear side of the reel sheet by the LED lamps, and, if a contrived illumination method is used, special expression of the game contents can be performed.

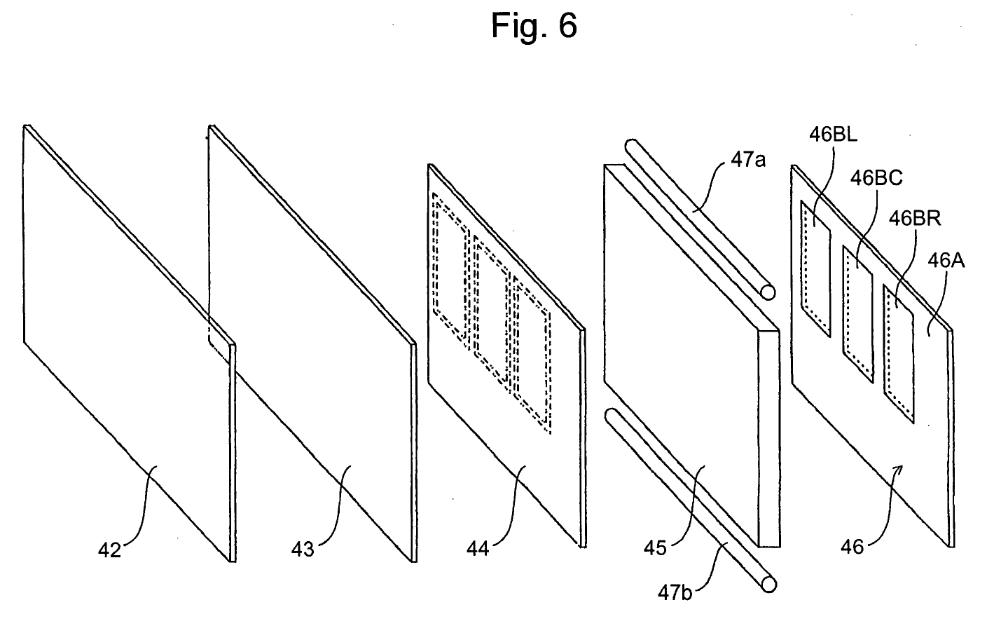

Now, the liquid crystal display apparatus 41 constituting the main display 5 will be described with reference to FIGS. 5 and 6. FIG. 5 is a perspective view showing a schematic construction of the liquid crystal display apparatus 41 as seen from the rear side of the housing 2. FIG. 6 is a partial exploded perspective view of the liquid crystal display apparatus 41.

The liquid crystal display apparatus 41 is disposed across the reels 3L, 3C, and 3R and at the front side of the reels 3L, 3C, and 3R with a predetermined interval from the reels 3L, 3C, and 3R. The liquid crystal display apparatus 41 includes a protective glass 42, a display panel 43, a liquid crystal panel 44, a light guiding plate 45, a reflective film 48, fluorescent lamps (white light sources) 47a, 47b, 48a, and 48b, lamp holders 49a to 49h, and a flexible substrate (not shown) which is connected to terminals of the liquid crystal panel 44 and constructed with a tape carrier package (TCP) mounting a driving IC for the liquid crystal panel 44.

The protective glass 42 and the display panel 43 has a property of light transmission. The protective glass 42 is mainly provided in order to protect the liquid crystal panel 44. On the display panel 43, a predetermined image (not shown) is drawn.

The liquid crystal panel 44 is constructed by sealing liquid crystal between a transparent substrate made of a glass plate in which thin film transistors are formed and another transparent substrate facing the transparent substrate and is provided with the design display regions 21L, 21C, and 21R. The liquid crystal panel 44 is constructed in a normally white mode in which, in a state that voltage is not applied to the liquid crystal (in a non-driven state), white display (light passes to a display surface side and the light can be externally perceived) is performed to be visible to the eye at the front sides of the reels 3L, 3C, and 3R. By disposing the liquid crystal panel 44 constructed in the normally white mode, although the sealed liquid crystal can not driven, the designs drawn on the reels 3L, 3C, and 3R can be perceived visually with eye through the design display regions 21L, 21C, and 21R, and by perceiving the changeable display and stop display of the reels 3L, 3C, and 3R, the game can be performed.

The light guide plate 45 has a property of light transmission and is disposed at the rear side of the liquid crystal panel 44 to guide out the light of the fluorescent lamps 47a and 47b from the liquid crystal panel 44.

The reflective film 46 is provided in order to reflect the light guided into the light guiding plate 45 into the front surface side of the light guiding plate 45 and is constructed by forming a sliver deposition film on a white polyester film or an aluminum film. The reflective film 46 includes a reflective region 46A and non-reflective regions 46BL, 46BC, and 46BR. The non-reflective regions 46BL, 46BC, 46BR are made of a transparent material and formed as a light transmitting portion for transmitting the incident light without refection thereof. In addition, the non-reflective regions 46BL, 46BC, and 46BR are disposed corresponding to the design display regions 21L, 21C, and 21R and at the front sides of the three vertical designs occurring when the rotation of the reels 3L, 3C, and 3R stops. The reflective region 46A reflects the incident light and mainly operates as an illuminating device for illuminating regions corresponding to the window frame display regions 22L, 22C, and 22R and the acting display regions 5a among the regions of the liquid crystal display apparatus 41.

The fluorescent lamps 47a and 47b are disposed along upper and lower end portions of the light guiding plate 45, and both end portions thereof are supported by the lamp holders 49a, 49b, 49g, and 49h. The fluorescent lamps 47a and 47b generate light which is incident on the light guiding plate 45 and serve as illuminating device for regions mainly corresponding to the window frame display regions 22L, 22C, 22R and the acting display regions 5a among the regions of the liquid crystal panel 44.

The fluorescent lamps 48a and 48b are disposed at upper and lower portions of the rear side of the reflective film 46 toward the reels 3L, 3C, and 3R. That is, the light emitted from the fluorescent lamps 48a and 48b is reflected from surfaces of the reels 3L, 3C, and 3R and is incident on the non-reflective regions 46BL, 46BC, and 46BR to illuminate the liquid crystal panel 44. By doing so, the fluorescent lamps 48a and 48b serve as illuminating device for illuminating the designs drawn on the reels 3L, 3C, and 3R and illumining device for illuminating the regions in the reflective film 46 corresponding to the design display regions 21L, 21C, and 21R.

On the other hand, in comparison to the liquid crystal display apparatus 41, a liquid crystal display apparatus 101 has different points in that a touch panel 56 is not disposed at the front side and the reels 3L, 3C, and 3R are not disposed at the rear side, but the other components are the same.

Internal Construction of Slot Machine

FIG. 7 is a block diagram mainly showing an internal construction of the slot machine 1A. The slot machine 1A has plural components around a control board 71 including a micro computer 31. The control board 71 includes the micro computer 31, a random number generator 35, a sampling circuit 36, a clock pulse generation circuit 37, a frequency divider 38, a hopper driving circuit 63, a payment completion signaling circuit 65, a sound control circuit 72, and an image control circuit 81.

The micro computer 31 includes a CPU (Central Processing Unit) 32, a RAM (Random Access Memory) 33, and a ROM (Read Only Memory) 34. The CPU 32 operates as various means having characteristics of the present invention according to programs stored in the ROM 34, inputs and outputs signals to the other components through the I/O port 39, and controls a whole operation of the slot machine 1A. The RAM 33 stores data or programs used for operation of the CPU 32, and for example, random number values which are sampled by a later-described sampling circuit 36 are temporarily stored and maintained therein. In addition, in the RAM 33, figurine information read out by a later described figurine information reading process is temporarily stored. ROM 34 stores a program executed by the CPU 32 and permanent data.

The random number generator 35 operates in response to a command of the CPU 32 to generate a predetermined range of random numbers. In response to a command of the CPU 32, the sampling circuit 96 extracts an arbitrary random number among the random numbers generated by the random number generator 35 and inputs the extracted random number to the CPU 32. The clock pulse generation circuit 37 generates a reference clock for operating the CPU 32, the frequency divider 38 inputs a signal divided from the reference clock in a predetermined period to the CPU 32.

In addition, a reel driving unit 50 is connected to the control board 71. The reel driving unit 50 includes a reel position detection circuit 51 for detecting positions of the reels 3L, 3C, and 3R and a motor driving circuit 52 for inputting a driving signal to motors M1, M2, and M3 for rotating the reels 3L, 3C, and 3R. By inputting the driving signal from the motor driving circuit 52, the motors M1, M2, and M3 operates to rotate the reels 3L, 3C, and 3R, respectively. In addition, a spin switch 8, a 1-BET switch 9, a maximum-BET switch 10, an inserted coin sensor 6a, and an inserted paper-money sensor 7a are connected to the control board 71, to which the components input signals.

The hopper driving circuit 63 drives the hopper 64 under the control of the CPU 32, the hopper 64 performs an operation for coin payment, and pays out the coins through a pay-out opening 13. The payment completion signaling circuit 65 receives coin number data from a coin detection unit 66 connected thereto and inputs a signal indicating coin payment completion to the CPU 32. The coin detection unit 66 counts the number of coins paid by the hopper 64 and inputs the data of the counted coin number value to the payment completion signaling circuit 65.

In addition, in response to a command of the CPU 32, the sound control circuit 72 controls a sound signal for outputting sound from the speakers 12L and 12R and outputs the sound from the speakers 12L and 12R. By doing so, various sounds are output from the speakers 12L and 12R for the purpose of producing effects of a game at a predetermined timing after starting of the game.

In addition, the touch panel 56 is connected to the CPU 32. The touch panel 56 is contact input device and disposed to cover the protective glass 42 at the front side of the main display 5. The touch panel 56 detects a position (contact position) on which a finger of the gamer or other contact member is contacted and inputs correspondence input information corresponding to the contact position to the CPU 32. For example, the touch panel 56 inputs information involved with no figurine selection displayed on the main display 5 to the CPU 32.

The image control circuit 81 controls image display in the liquid crystal display apparatus 41 and the liquid crystal display apparatus 101.

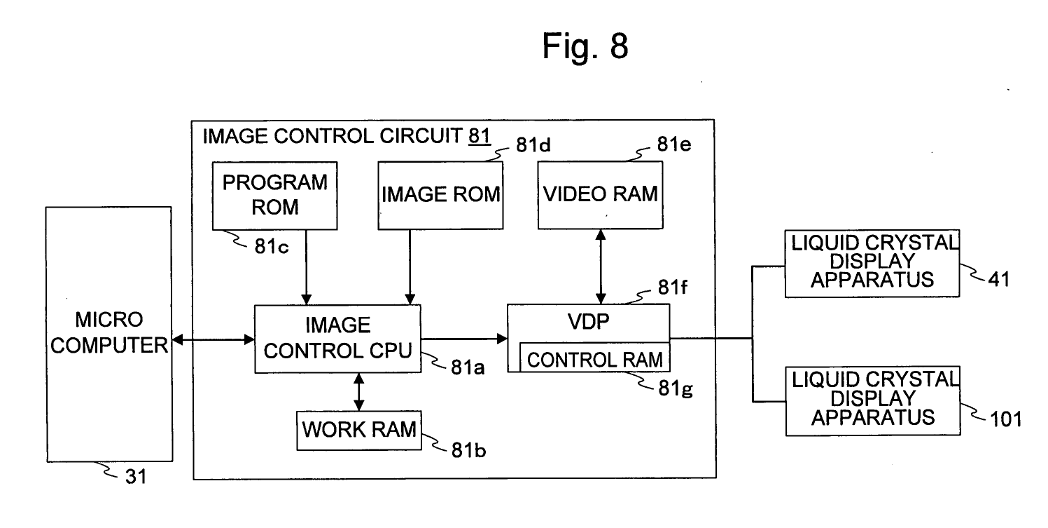

As shown in FIG. 8, the image control circuit 81 includes an image control CPU 81a, a work RAM 81b, a program ROM 81c, an image ROM 81d, a video RAM 81e, and a VDP (Video Display Processor) 81f. The image control CPU 81a determines an image displayed on the liquid crystal display apparatus 41 and the liquid crystal display apparatus 101 based on a parameter set by the micro computer 31 according to an image control program (associated with display on the liquid crystal display apparatus 41 and the liquid crystal display apparatus 101) stored in advance to a program ROM 81c. The work RAM 81b is constructed as temporary storage device at the time that the image control CPU 81a executes the image control program.

The program ROM 81c stores the image control program, various selection tables, or the like. The image ROM 81d stores data date for forming an image. The video RAM 81e is constructed as temporary storage device at the time that the image is formed by the VDP 81f. The VDP 81f includes a control RAM 81g, forms an image according to the display contents of the liquid crystal display apparatuses 41 and 101 determined by the image control CPU 81a, and outputs the formed image to the liquid crystal display apparatuses 41 and 101.

Construction of Figurine

As shown in FIG. 9, the figurine 90 includes a stand member 91, a figurine main body unit 92, and an IC chip 93 for storing figurine information.

The stand member 91 has a size corresponding to the stand mounting unit 19 a of the figurine mounting unit 19 and is formed in a shape of a cylinder with a top portion 91a and a bottom portion, and the IC chip 93 is engaged and fixed into an open end portion thereof.

The figurine main body unit 92 is constructed with a leg stand portion 92a fixed on the top portion 91 of the stand member 91 and a doll portion 92b erected from the leg stand portion 92a which has a three-dimensional shape like a wizard or a warrior. In addition, the figurine 90 corresponds to a game item in the present invention.

Figurine information is stored in the IC chip 93. The figurine information includes information (bonus game number information and, hereinafter, referred to as figurine number information) indicating a game number at the time of transition from a standard game state to a high-probability game state and information (specific probability information and, hereinafter, referred to as figurine probability information) indicating a probability for transition from the high-probability game state to a free game. That is, the IC chip reader/writer c (reader) built in the figurine mounting unit 19 can read from the figurine 90 the information including at least the figurine number information and the figurine probability information as the information on the figurine 90.

Operational Contents of Slot Machine

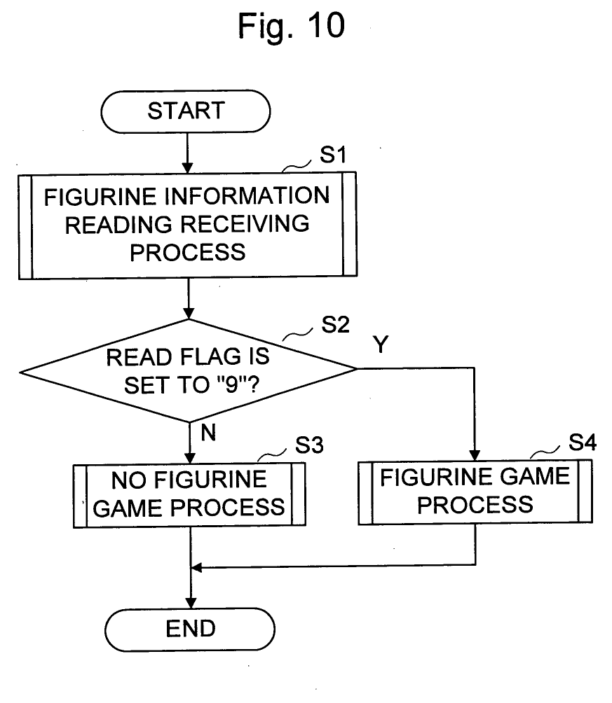

In the slot machine 1A according to the present invention, the CPU 32 operates as a game playing controller and controls game playing in the base game mode and the bonus game mode. Now, examples of operations of the slot machine 1A will be described with reference to flowcharts shown in FIGS. 10 to 13.

FIG. 10 is a flowchart showing divided blocks of operations from the starting to the ending of a game of the slot machine 1A. In addition, in FIGS. 10 to 14, Steps are abbreviated as “S”.

If a main process starts as shown in FIG. 10, the slot machine 1A proceeds to Step 1 to receive a selection whether or not a gamer plays a game using the figurine 90 and, when the figurine information is read, a figurine information reading receiving process for setting a later-described read flag to “9” is performed. By proceeding to Step 2, the process is divided according to whether or not the read flag is set to “9”. If the read flag is set to “9”, no figurine game process (Step 3) is performed, and if not, figurine game process (Step 4) is performed.

If the game processes end, the main process ends. Now, the blocks will be described in detail.

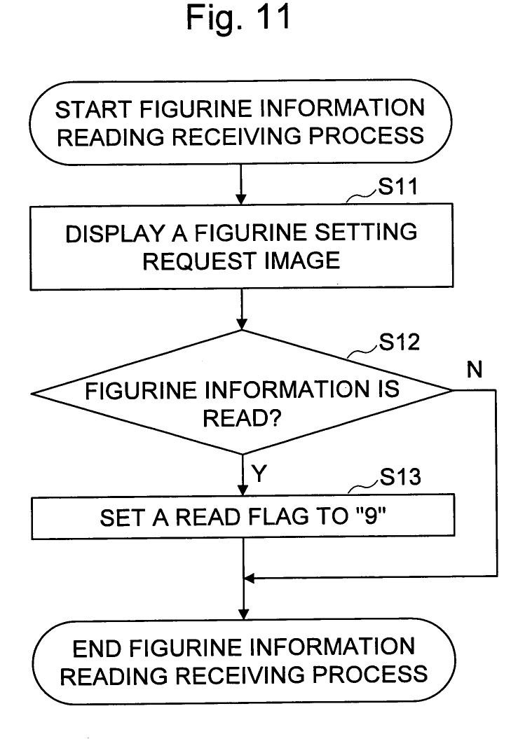

By proceeding to Step 1, if a figurine information reading receiving process starts, Step 11 of FIG. 11 is performed, so that the CPU 32 commands and requests the image control circuit 81 to perform figurine setting on the main display 5 and displays an image (hereinafter, referred to as a request image) for requesting “no figurine” selection for a gamer not having any figurine. In response to the “request image”, the gamer sets the figurine 90 in the figurine mounting unit 19, if having the figurine 90, and selects “no figurine” by touching the touch panel 56, if not. In a case where the figurine 90 is set in the figurine mounting unit 19, the IC chip reader/writer (reader) 19c reads the figurine information on the set figurine 90.

Next, by proceeding to the subsequent Step 12, the CPU 32 determines whether or not chip reader/writer 19c succeeds in figurine information reading. Next, if the figurine information reading can be performed in a predetermined time, Step 13 is performed. In Step 13, the read flag is set to predetermined information (for example, “9”) and the figurine information reading receiving process ends. On the other hand, if there is no input of the figurine information in a predetermined time or if “no figurine” selection is performed with the touch panel 56, the figurine information reading receiving process ends without Step 13 preformed.

Returning to FIG. 10, by proceeding to Step 2 following Step 1, the CPU 32 determines whether or not the read flag is set to “9”. If the read flag is not set to “9”, by proceeding to Step 3, the no figurine game process is performed, and if not, by proceeding to Step 4, the figurine game process is performed.

No Figurine Game Process

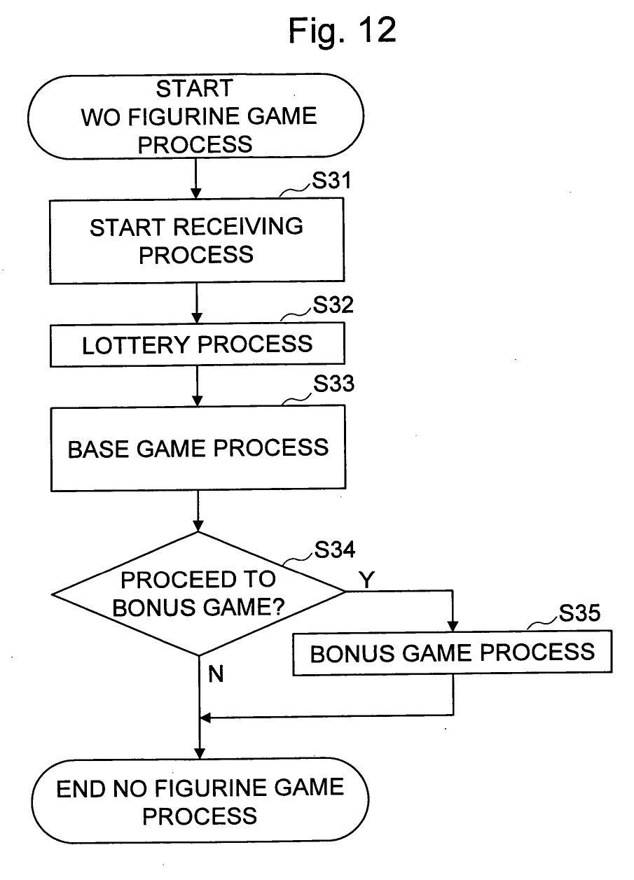

If the figurine game process starts by proceeding from Step 2 to Step 3, the CPU 32 performs a sequence of processes shown in FIG. 12. That is, if the no figurine game process start, a start receiving process is firstly performed as Step 31. By proceeding to the start receiving process, the slot machine 1A waits for a game starting manipulation from the gamer under the control of the CPU 32. Here, since the slot machine 1A is a coin inserting type game machine, the game starting manipulation is a manipulation of pushing the spin switch 8 after inserting a predetermined number of coins into the coin insertion slot 6 or after-pushing the 1-BET switch 9 or the maximum BET switch 10 in order to maintain a coin credit stored in the slot machine 1A. If the gamer pushes the spin switch 8, a start signal is transmitted from the spin switch 8 to the CPU 32, and the next process (Step 32) is performed.

Next, in Step 32, the CPU 32 operates as game mode controller and performs a lottery for transition into a bonus game by using a random number-generated in cooperation with the aforementioned random number generator 35 and the sampling circuit 36. More specifically, a number among 120 numbers is defined as a number for transition into the bonus game, and if the random number matches with the number, the transition to the bonus game is determined. That is, the transition probability for the bonus game is defined as P0 (=1/120). Next, in Step 33 following the lottery process, a base game process for rotating the reels 3L, 3C, and 3R in a base game mode and then stopping the reels corresponding to a result of the lottery process is performed. In the base game process, if a marker besides the bonus game is awarded, coin payment is performed based on a dividend according to an award state, and then, Step 34 is performed.

By proceeding to Step 34, it is determined based on the result of the lottery process in Step 32 whether or not the transition into the bonus game is performed. Here, in a case where the transition into the bonus game is determined by the lottery process, by proceeding to Step 35, the bonus game process is performed. In the other cases, the no figurine game process ends without the bonus game process performed.

In addition, if the bonus game process starts by proceeding to Step 35, the game mode becomes the bonus game mode, a plural-times (for example, three-times) free game is performed as the bonus game. In the free game, a game the same as the base game is performed without a new coin being inserted, and coin payment is performed based on a dividend according to a combination of stopped designs. For this reason, in the bonus game mode, the gamer can acquire more coins than the base game mode. In addition, if the three-times free game and the bonus game process end, the no figurine game process ends.

Figurine Game Process

In the slot machine 1A according to the present invention, in a case where the gamer plays a game by using the figurine 90, there is provided two game states, that is, a standard game state where a transition probability (a first transition probability in the present invention) from the base game mode into the bonus game mode is a standard transition probability and a high-probability game state where a transition probability into the bonus game mode is higher than that of the standard game state.

By proceeding from Step 2 to Step 4, if the figurine game process starts, a game state transition condition from the standard game state to the high-probability game state is firstly set in Step 41. More specifically, a predetermined game number (predetermined slot game number in the present invention) during the transition of the game state from the standard game state to the high-probability game state and a high transition probability (a second transition probability in the present invention) in the high-probability game state are set. Next, the CPU 32 determines as the predetermined game number a number C1 represented by the figurine number information included in the figurine information read from the figurine 90 by the IC chip reader/writer 19c and, similarly, determines as the high transition probability a probability P1 represented by the figurine probability information included in the figurine information.

Next, if the game state transition condition is set in Step 41, in the subsequent Step 42, the CPU 32 operates as counter and starts counting of the game number. In addition, at the time of starting the figurine game process, the count of the game number is set to 0.

Next, in the subsequent Step 43, the CPU 32 operates as probability changer and determines whether or not the game number counted in Step 42 reaches the predetermined game number C1 (that is, the number represented by the figurine number information). If the game number does not reach the predetermined game number C1, the standard game process (Step 44) for providing the gamer with a game in the standard game state is performed, and if the game number reaches the predetermined game number C1, the high-probability game process (Step 45) for providing the gamer with a game in the high-probability game state is performed.

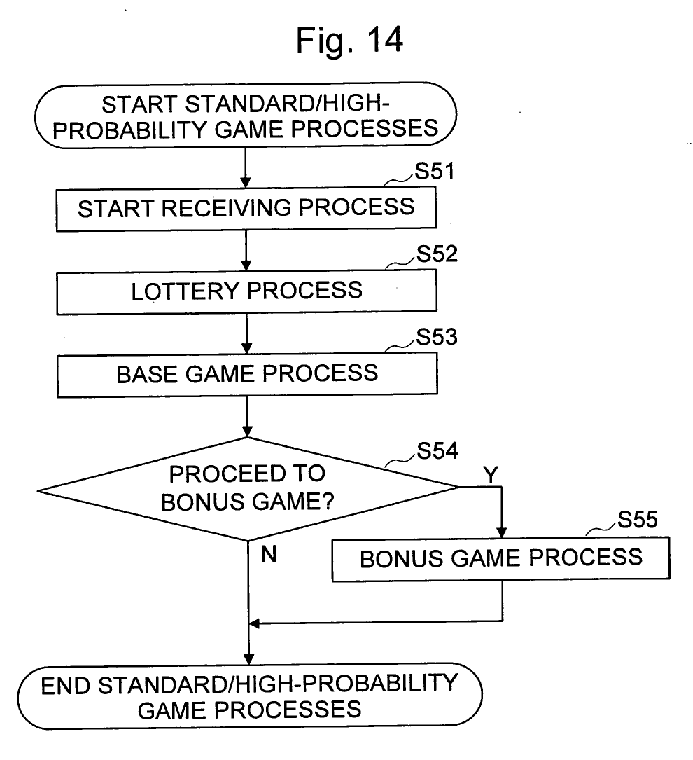

As shown in FIG. 14, the standard game process and the high-probability game process are equivalent to the aforementioned no figurine game process (see FIG. 12). That is, after a start receiving process the same as that of Step 31 is performed in Step 51, the CPU 32 operates as game mode controller and performs the lottery process the same as that of Step 32 in Step 52.

However, at the time of the lottery process in Step 52, the standard game process of Step 44 uses as the transition probability into the bonus game the standard transition probability P0 the same as that of the no figurine game process, and the high-probability game process of Step 45 uses as the transition probability into the bonus game the high transition probability P1 (=1/110) (the probability represented by the figurine probability information). In addition, as described above, since the probability P0 is 1/120, the probability P1 is higher than the probability P0.

Next, after a base game process the same as that of Step 33 is performed as Step 53 following the lottery process, by proceeding to Step 54, it is determined based on a result of the lottery process in Step 52 whether or not the transition into the bonus game is performed. Here, in a case in which the transition into the bonus game is determined by the lottery process, by proceeding to Step 55, the bonus game process is performed, and then, the standard game process or the high-probability game process ends. In the other cases, the standard game process or the high-probability game process ends without the bonus game process performed. In addition, in a case in which the bonus game process is performed, the CPU 32 clears the count of the game number to 0 similar to the case of starting the figurine game process.

If any one of the standard game process and the high-probability game process ends, the CPU 32 operating as the counter adds 1 to the game number in Step 46. Next, the processes from the game number determination process (Step 43) to the game number addition process (Step 46) repeat until a process ending condition is satisfied. The determination of the process ending condition is performed in Step 47 following Step 46. In addition, the process ending condition is satisfied in a case in which the figurine sensor 19d senses that the gamer detaches the figurine 90 from the figurine mounting unit 19 or in a case in which the gamer inputs an ending command to the slot machine 1A by using the touch panel 56.

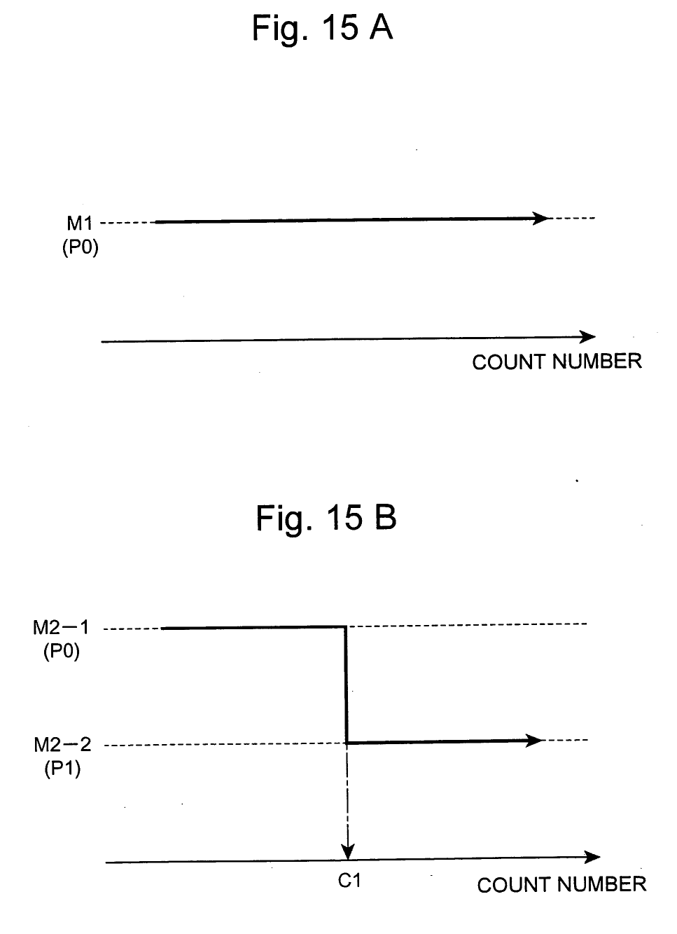

Now, a transition probability to the bonus game in the standard game state and the high-probability game state in the aforementioned no figurine and figurine game processes will be described with reference to FIG. 15. In addition, FIG. 15A shows a timing chart in the no figurine game-mode, and FIG. 15B shows a timing chart in the figurine game mode.

Firstly, as shown in FIG. 15A, in the no figurine game mode (M1), although the gamer repeats the game as a base game to increase the game number, the transition probability (P0) to the bonus game does not change. On the other hand, as shown in FIG. 15B, in the figurine game mode, at the time that a game number after the figurine game state starts or a game number after the ending of the previous bonus game state reaches a predetermined number (that is, predetermined game number C1), the game state is transitioned from the standard game state (M2-1) to the high-probability game state (M2-2), and at the same time, the transition probability to the bonus game changes from the standard transition probability P0 to the high transition probability P1.

As described above in detail, in the slot machine 1A, when the gamer mounts the figurine 90 in the figurine mounting unit 19, the figurine information stored in the figurine 90 is read by the IC chip reader/writer 19c. If the reading of the figurine information is performed by the IC chip reader/writer 19c, the CPU 32 starts counting of the game number. Next, if the game number reaches the predetermined game number C1, the CPU 32 operating as probability changer transitions the game mode from the standard game mode to the high-probability game mode, so that the transition probability can be changed from the standard transition-probability P0 to the high transition probability P1 (>P0). Therefore, in the slot machine 1A, the gamer plays the game by using the figurine 90, so that the game can be played in a high transition probability from the base game mode to the bonus game mode.

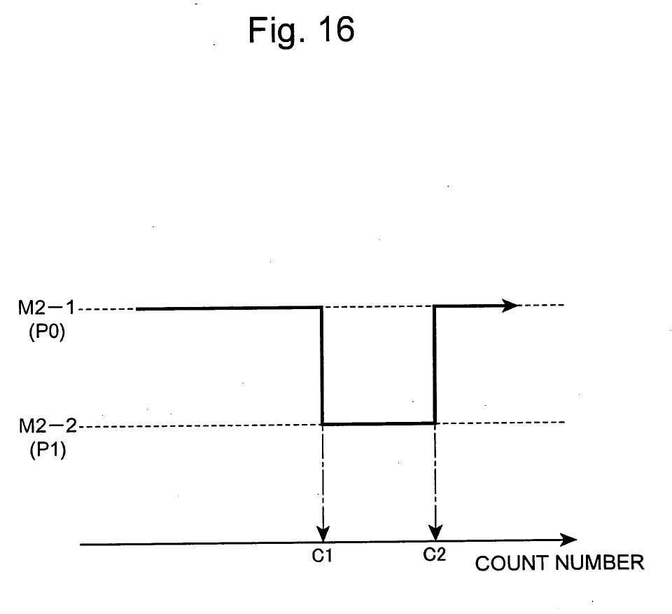

In addition, although an example in which the figurine information on the figurine 90 read by the IC chip reader/writer 19c includes only one figurine number information is described above, a plurality of the figurine number information may be included in the figurine information. In this case, one figurine number information properly selected may be used. In addition, two figurine number information may be used, and at the same time, the number C1 represented by the one figurine number information may be used as the aforementioned predetermined game number and the number C2 (>C1) represented by the other figurine number information may be used to define an ended game number. In this case, as shown in FIG. 16, a process for returning the game mode from the high-probability game state (M2-2) in which the game number exceeds C1 to the standard game state (M2-1) in which the game number is C2 (>C1) can be performed.

### Second Embodiment

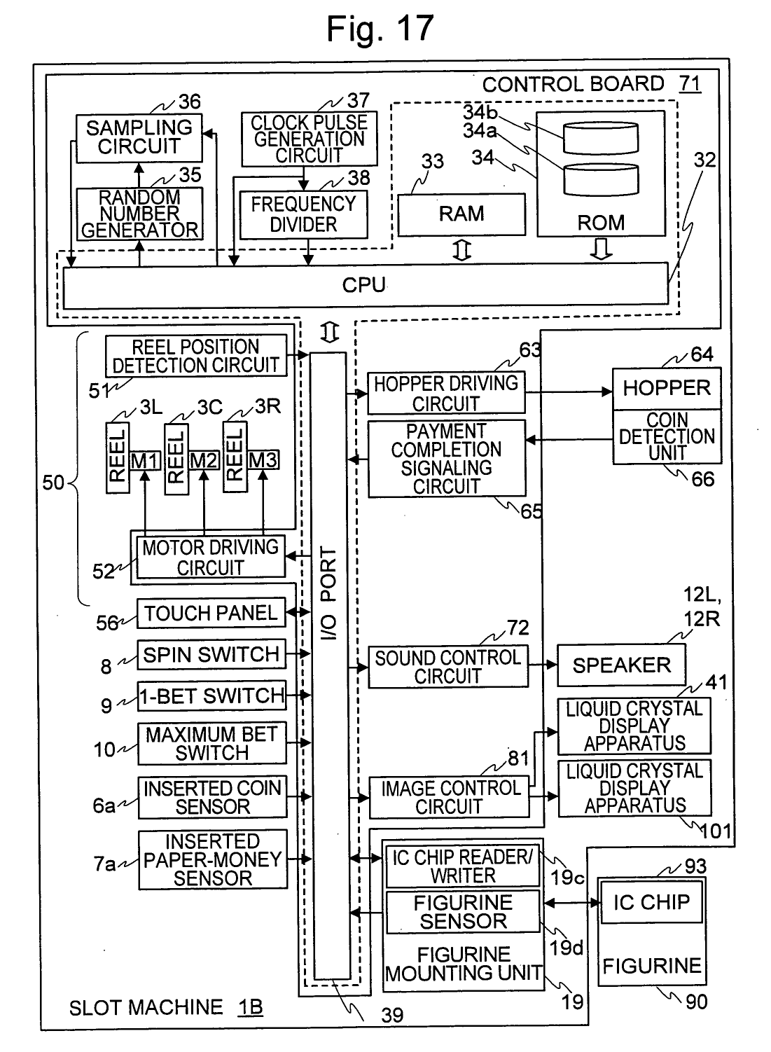

Now, a slot machine 1B according to a second embodiment will be described with reference to FIG. 17. Here, FIG. 17 is a block diagram mainly showing an internal construction of the slot machine 1B.

As shown in FIG. 17, the slot machine 1B is different from the slot machine 1A in that a game number database 34a and a transition probability database 34b are stored in a ROM 34. In the game number database (number storage unit) 34a, information equivalent the aforementioned figurine number information, that is, information representing the game number C1 is stored. In addition, in the transition probability database (probability storage unit) 34b, information equivalent the aforementioned figurine probability information, that is, information representing the transition probability P1 is stored.

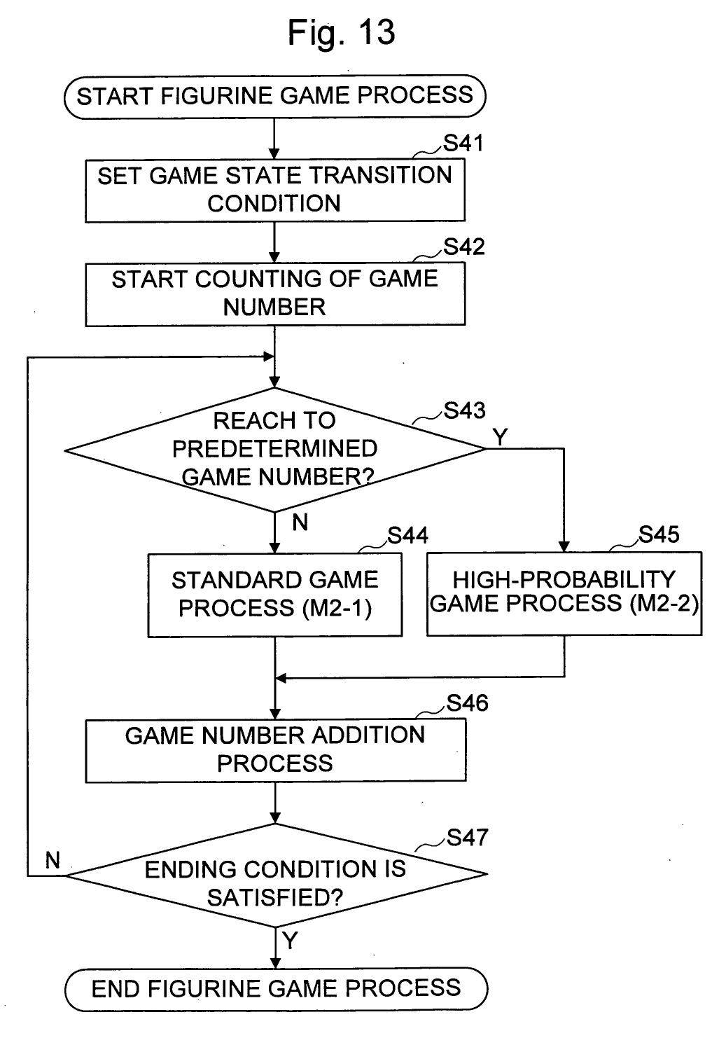

In addition, unlike the first embodiment, in the second embodiment, at the time of setting the game state transition condition of the figurine game mode (see S41 in FIG. 13), the CPU 32 determines the game number C1 stored in the game number database 34a as the predetermined game number and the probability P1 stored in the transition probability database 34b as the high transition probability.

In a case in which such processes are performed, the same effect as the aforementioned slot machine 1A can be obtained. In addition, similar to the first embodiment, a plurality of information may be suitably stored in the game number database 34a or the transition probability database 34b. That is, in this case, a process for selectively using one of the figurine number information or a process for returning the high-probability game state (M2-2) in which the game number exceeds Cl to the standard game state (M2-1) in which the game number is C2 (>C1) may be performed, as shown in FIG. 16.

### Third Embodiment

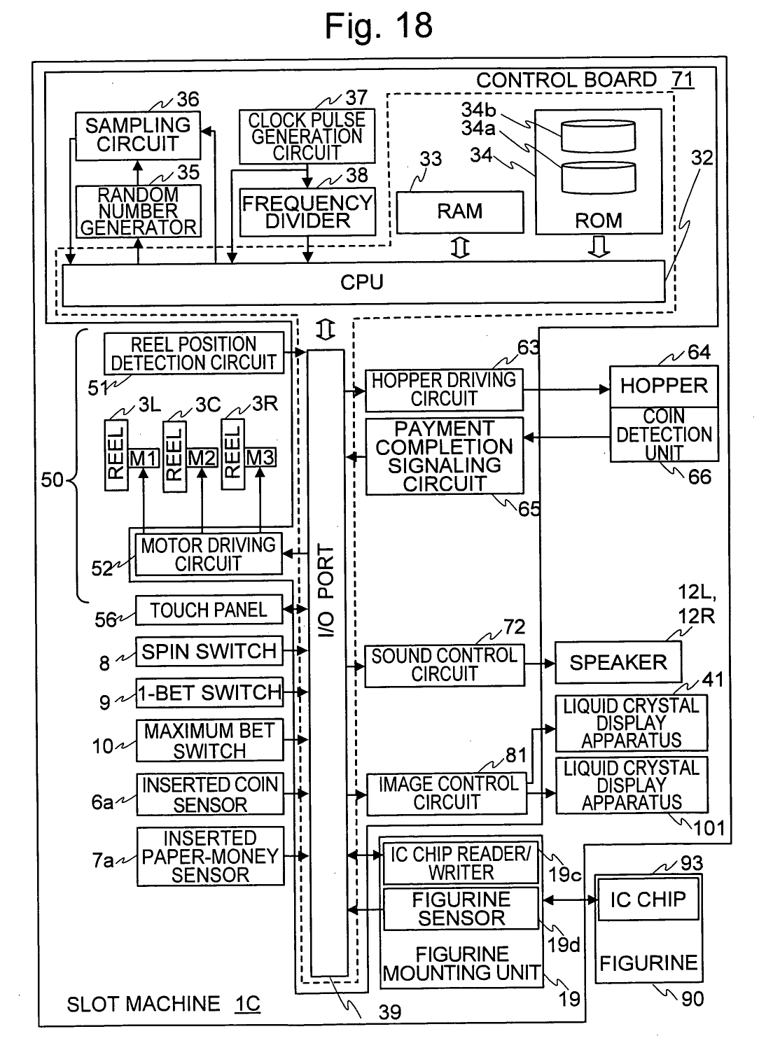

Now, a slot machine 1C according to a third embodiment will be described with reference to FIGS. 18 to 20. Here, FIG. 18 is a block diagram mainly showing an internal construction of the slot machine 1C.

Firstly, information on a figurine 90 used for the slot machine 1C will be described. In the embodiment, a figurine ID as the figurine information is stored in the figurine 90. The figurine ID is constructed with an alphabet and a 4-digit number. The alphabet indicates a type of figurine corresponding a three-dimensional shape of the figurine main body unit 92 (for example, “A”, “B”, and “C” indicating a wizard, a warrior, and common people, respectively), and the four-digit number indicates unique identification information for identifying the figurines (identifying oneself and others). That is, with respect to the figurine 90, the gamer can identify types of characters according to the three-dimensional shape of the figurine main body unit 92, and the slot machine 1C can identify the individual figurines according to the figurine IDs. In addition, in the case of the figurine 90 shown in FIG. 9, the figurine ID is “B1001”, in which “B” is type and “1001” is identification information.

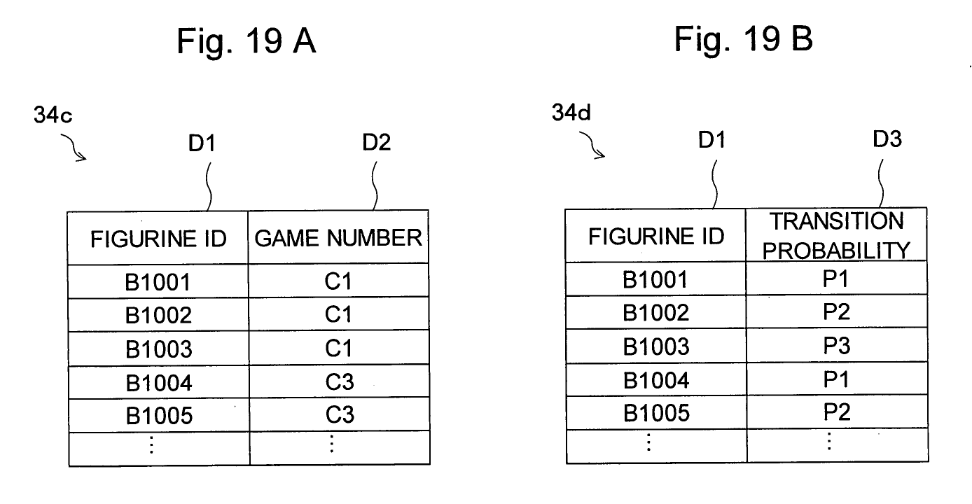

In addition, in the slot machine 1C, the figurine IDs and the game number and transition probability are stored in association with each other in the game number database 34c and the transition probability database 34d the same as those of the slot machine 1B. That is, in the game number database 34c, an item D1 in which a plurality of the figurine IDs are aligned and an item D2 in which the game numbers having the same number as that of the item D1 are aligned are stored in one-to-one correspondence state (see FIG. 19A), and in the transition probability database 34d, an item D1 in which a plurality of the figurine IDs are aligned and an item D3 in which the transition probabilities having the same number as that of the item D1 are aligned are stored in one-to-one correspondence state (see FIG. 19B).

In addition, in the third embodiment, the figurine ID is read in Step 12 (see FIG. 11) of the aforementioned figurine information reading receiving process, and the figurine ID is temporarily stored in a RAM 33. Next, at the time of setting the game state transition condition of the figurine game mode (see Step 41 in FIG. 13), the CPU 32 extracts the game number C1 stored in association with the corresponding figurine ID (B1001) in the game number database 34c by using the figurine ID stored in the RAM 33 as a search key and determines the extracted game number C1 as the predetermined game number. In addition, the CPU 32 extracts the transition probability P1 stored in association with the corresponding figurine ID (B1001) in the transition probability database 34d by using the figurine ID stored in the RAM 33 as a search key and determines the extracted transition probability P1 as the high transition probability.

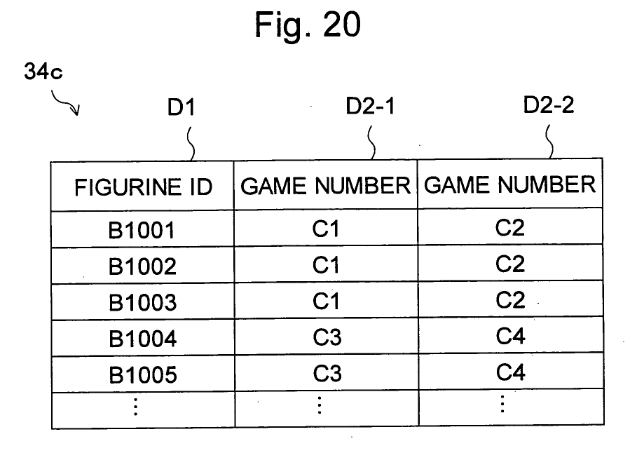

In a case in which such processes are performed, the same effect as the aforementioned slot machines 1A and 1B can be obtained. In addition, similar to the first and second embodiments, in the third embodiment, a process for returning the high-probability game state (M2-2) in which the game number exceeds C1 to the standard game state (M2-1) in which the game number is C2 (>C1) may be performed, as shown in FIG. 16. In this case, as shown in FIG. 20, in the game number database 34c, the item D1 for the figurine IDs and two items of the item D2-1 for the predetermined game numbers and the item D2-2 for the ending game numbers may be stored in association with each other.

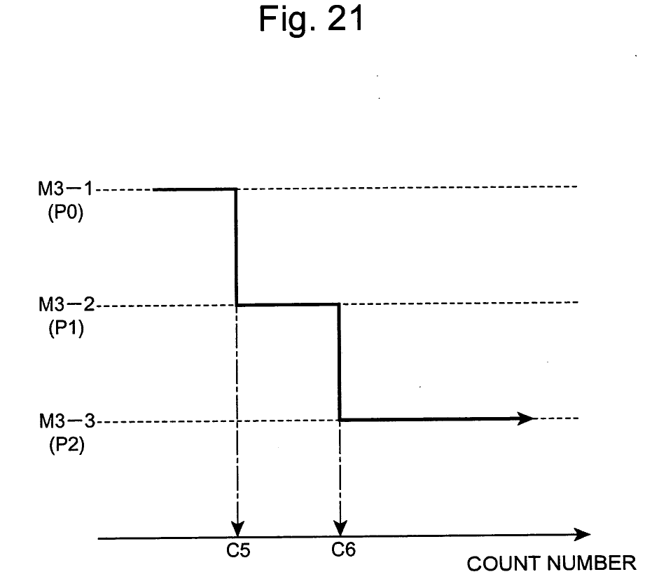

In addition, in aforementioned first, second, and third embodiments, although two game modes (that is, the standard game mode and the high-probability game mode) having different transition probabilities to the bonus game in the figurine game mode are described, the number of game modes is not limited to two, and 3 or more may be suitably used. That is, as shown in FIG. 21, the CPU 32 may selectively determine the game mode based on the game number at the current time by using a plurality of game number information C5 and C6 and a plurality of transition probability information P0, P1, and P2 stored in the slot machine 1A, 1B, or 1C or in the figurine 90.

### Fourth Embodiment

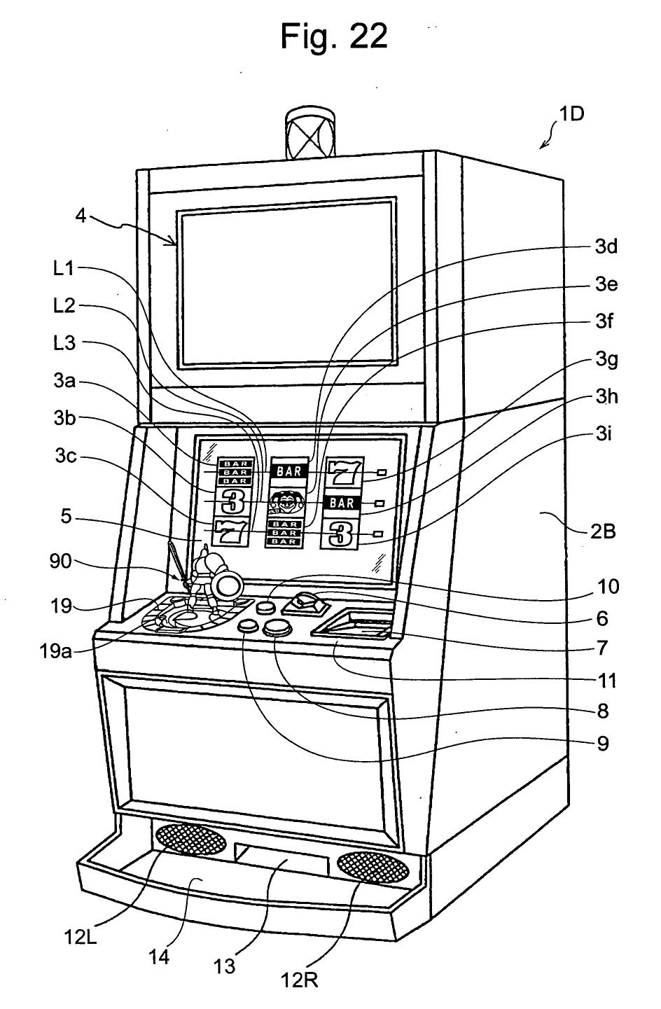

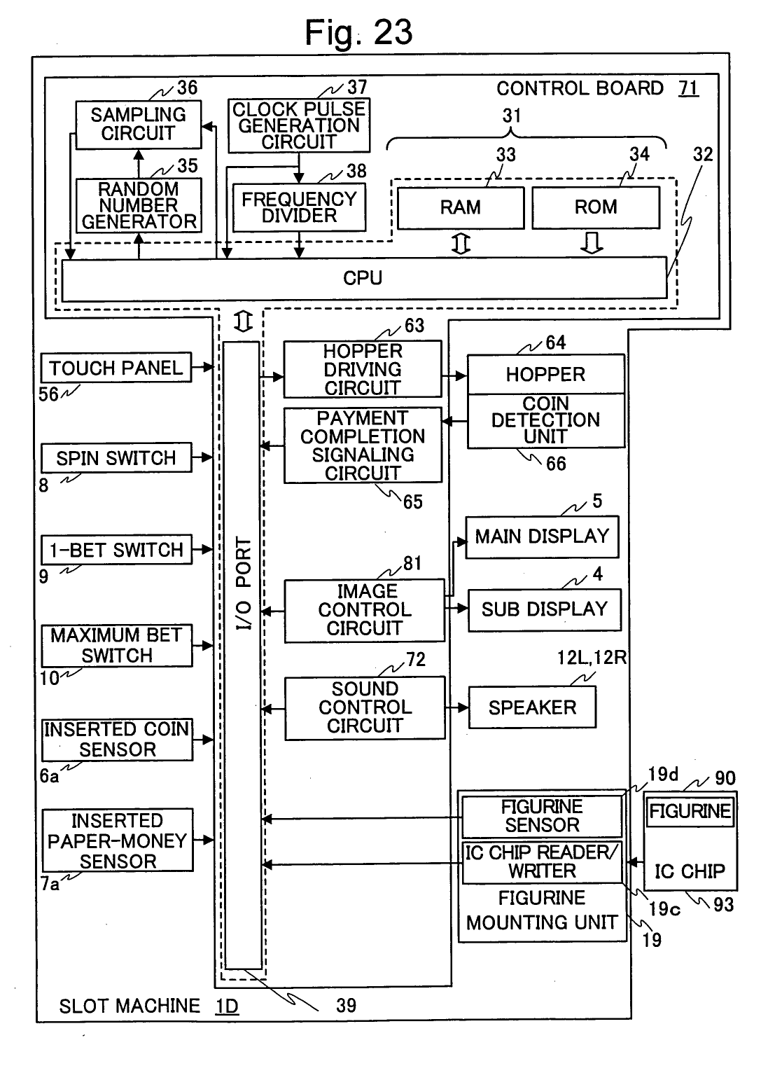

Now, a slot machine 1D according to a fourth embodiment will be described with reference to FIGS. 22 and 23. FIG. 22 is a perspective view showing an overall construction of the slot machine 1D according to the embodiment, and FIG. 23 is a block diagram mainly showing an internal construction thereof.

The slot machine 1D is a so-called video slot machine for displaying a changeable display image on a display, and the slot machine 1D is different from the aforementioned mechanical reel type slot machines 1A, 1B, and 1C in terms of the changeable display device and substantially equal thereto in terms of other components. More specifically, instead of the reels 3L, 3C, and 3R of the aforementioned slot machine 1A, 1B, and 1C, the slot machine 1D is constructed to have changeable display portions for displaying plural columns (three columns) displaying changeable display images of designs and performs a changeable display image game (video slot game) by using the changeable display images displayed on the changeable display portions.

A main display 5 of the slot machine 1D has a total of nine changeable display portions 3a, 3b, 3c, 3d, 3e, 3f, 3g, 3h, and 3i aligned in horizontal and vertical three columns. In the base game mode and the bonus game mode, scroll display images (reel images displayed like the mechanical reels rotating) in which a plurality of the designs move downwards are displayed on the changeable display portions 3a to 3i of the main display 5. In addition, in FIG. 22, although vertical three columns of effective lines (L1 to L3) are provided, a total of eight effective lines (horizontal and vertical three columns of the changeable display portions 3a to 3i and two diagonal lines) may be provided.

Now, operational contents of the slot machine 1D will be described. Although a main process of the slot machine 1D is basically the same as that of the slot machine 1A, instead of rotating the reels 3L, 3C, and 3R, the slot machine 1D performs changeable display of the designs on the changeable display portions 3a to 3i in the base game mode and the bonus game mode. In addition, in the slot machine 1D, since the reels 3L, 3C, and 3R are not used, there is no limitation on the number of designs, and the transition probabilities can be changed by freely changing types of designs corresponding to the random numbers.

Such a slot machine 1D has operations and effects similar to or equivalent those of the slot machines 1A, 1B, and 1C.

### Fifth Embodiment

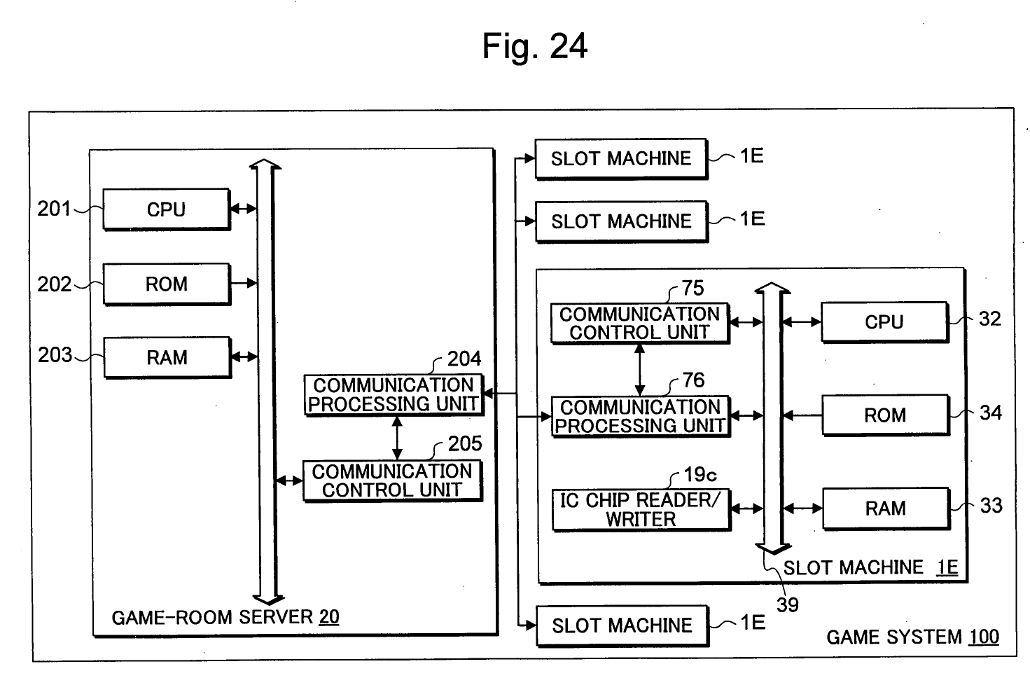

Now, an embodiment of a game system according to the present invention will be described. FIG. 24 is a block diagram showing a schematic construction of the game system according to the embodiment. The game system 100 includes a game-room server 20 installed in a game room and a plurality (four in the embodiment) of slot machines 1E communicationably connected to the game-room server 20, and a LAN is constructed in the game room by connecting the game-room server 20 and the slot machines 1E via a private line.

The game-room server 20 corresponds to a game server, and each of the slot machines 1E corresponds to a game machine, in the present invention. The slot machines 1E have the same construction and function as the slot machines 1A to 1D according to the first to fourth embodiments.

The game-room server 20 includes a CPU 201, a ROM 202, a RAM 203, a communication processing unit 204, and a communication control unit 205, and although not shown, the aforementioned game number database 34c and transition probability database 34d are stored in the ROM (storage unit) 202.

The CPU 201 reads and writes data from and to the RAM 203 according to a program stored in the RAM 202 and, in response to a command of the CPU 201, the communication control unit 205 drives the communication processing unit (receiver, transmitter) 204 to perform data reception and transmission between the slot machines 1E. In addition, the CPU 201 operates as information extractor to extract game number information (for example, game number C1) and transition probability information (for example, transition probability P1) from the ROM 202 based on figurine IDs transmitted from the slot machines 1E and transmits the information from the communication processing unit 204 to the slot machines 1E.

The slot machines 1E are different from the slot machine 1A, 1B, 1C, and 1D in terms of including a communication control unit 75 and a communication processing unit 76. The communication control unit 75 and the communication processing unit 76 are connected through an I/O port 39 to the CPU 32, and in response to a command of the CPU 32, the communication control unit 75 drives the communication processing unit (communication device) 76 to perform data reception and transmission from and to the game-room server 20.

Flow of information of the game system 100 having the aforementioned construction is similar to the flow of information in the aforementioned third embodiment. That is, in the slot machine 1C according to the third embodiment, the figurine IDs read from the figurine 90 are temporarily stored in the RAM 33, and at the time of setting the game state transition condition of the figurine game mode (see S41 in FIG. 13), the CPU 32 extracts the game number C1 stored in the game number database 34c and the transition probability P1 stored in the transition probability database 34d by using the figurine IDs stored in the RAM 33 as a search key. On the other hand, in the game system 100, although the figurine IDs read from the figurine 90 are temporarily stored in the RAM 33, but the game number C1 and the transition probability P1 are extracted from the game number database 34c and the transition probability database 34d stored in the ROM 202 of the game-room server 20 instead of the ROM 32 thereof. At the time of extraction, various data exchange is performed in cooperation with the communication processing unit 76 of the slot machines 1E and the communication processing unit 204 of the game-room server 20.

That is, the figurine IDs read from the figurine 90 are transmitted from the slot machines 1E to the communication processing unit 204 of the game-room server 20, and in contrast, the game number C1 and the transition probability P1 stored in the game number database 34c and the transition probability database 34d in association with the figurine IDs are transmitted from the game-room server 20 to the slot machines 1E.

Therefore, the game system 100 has operations and effects similar to or equivalent those of the slot machine 1C according to the third embodiment.

### Sixth Embodiment

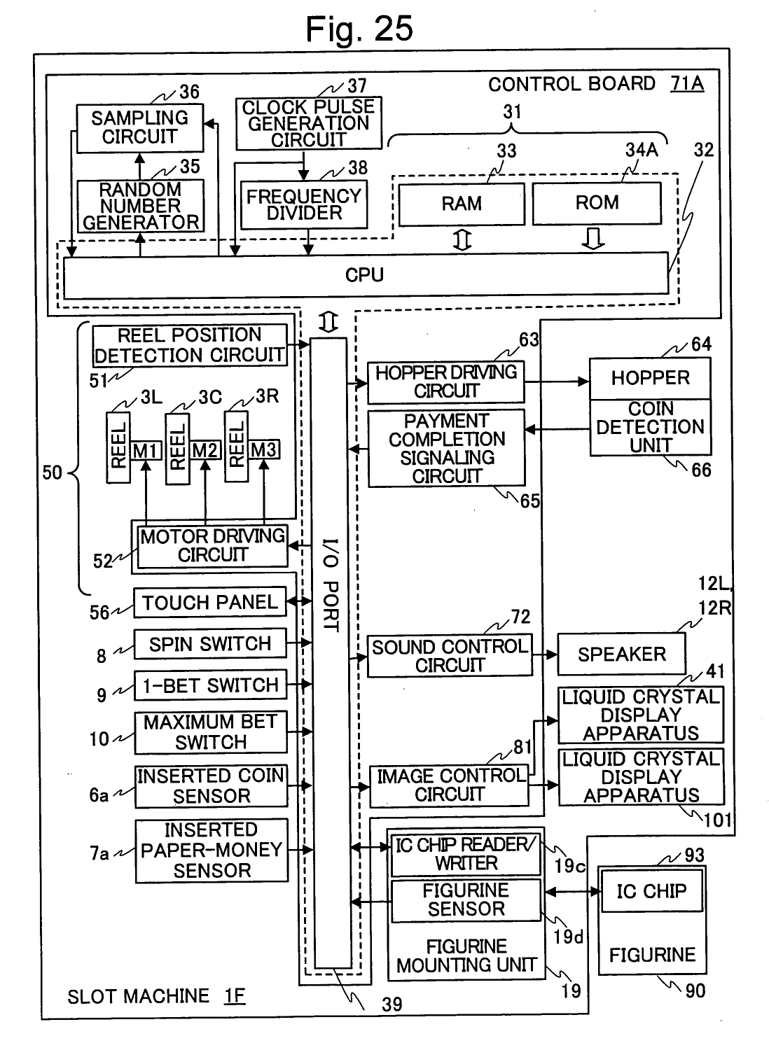

FIG. 25 is a block diagram of a slot machine 1F mainly showing an internal construction thereof. The slot machine 1F includes a plurality of components around a control board 71A including a micro computer 31. The control board 71A includes the micro computer 31, a random number generator 35, a sampling circuit 36, a clock pulse generation circuit 37, a frequency divider 38, a time counting circuit 53, a hopper driving circuit 63, a payment completion signaling circuit 65, a sound control circuit 72, and an image control circuit 81.

Time counting circuit 53 is able to count time. The circuit starts to count time and outputs the counted time and resets the counted time, etc., according to the instruction of CPU 32. The CPU 32 measures the elapse of an instructed period, thereby.

Operational Contents of Slot Machine

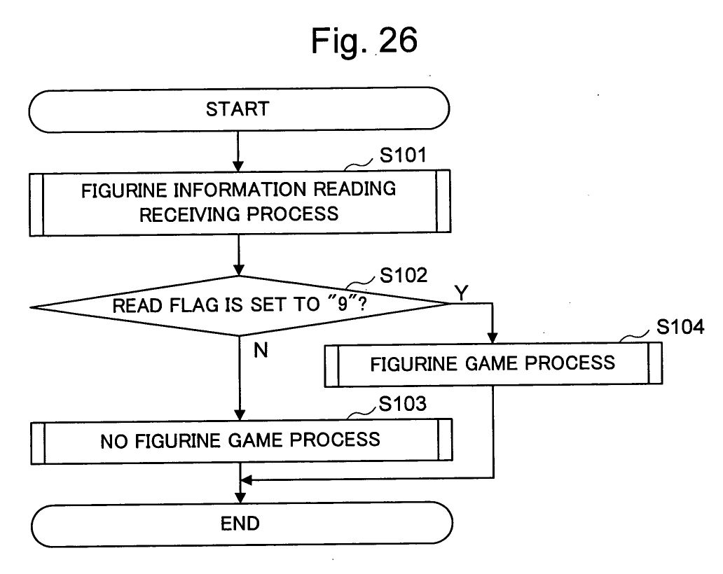

In the slot machine 1F according to the embodiment, the CPU 32 operates as game playing controller and controls game playing in the base game mode and the bonus game mode. Now, examples of operations of the slot machine 1F will be described with reference to flowcharts shown in FIGS. 26 to 29.

FIG. 26 is a flowchart showing divided blocks of operations from the starting to the ending of a game of the slot machine 1F. In addition, in FIGS. 26 to 30, Steps are abbreviated as “S”.

If a main process starts as shown in FIG. 26, the slot machine 1F proceeds to Step 101 to receive a selection whether or not a gamer plays a game using the figurine 90 and, when the figurine information is read, a figurine information reading receiving process for setting a later-described read flag to “9” is performed. By proceeding to Step 102 proceeds, the process is divided according to whether or not the read flag is set to “9”. If the read flag is set to “9”, a no figurine game process (Step 103) is performed, and if not, figurine game process (Step 104) is performed.

If the game processes end, the main process ends. Now, the blocks will be described in detail.

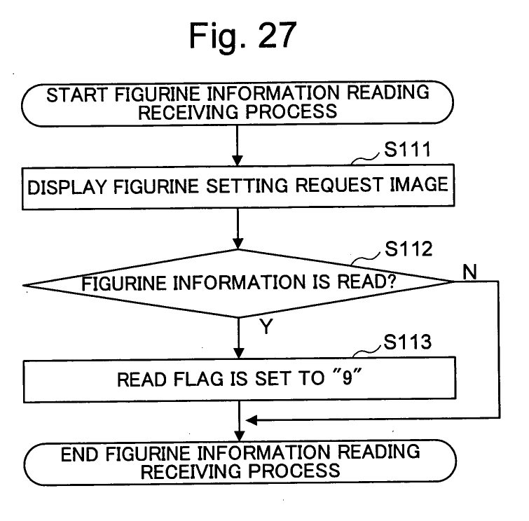

By proceeding to Step 101, if a figurine information reading receiving process starts, Step 111 of FIG. 27 is performed, so that the CPU 32 commands and requests the image control circuit 81 to perform figurine setting on the main display 5 and displays an image (hereinafter, referred to as a request image) for requesting “no figurine” selection for a gamer not having any figurine. In response to the “request image”, the gamer sets the figurine 90 in the figurine mounting unit 19, if having the figurine 90, and selects “no figurine” by touching the touch panel 56, if not. In a case in which the figurine 90 is set in the figurine mounting unit 19, the IC chip reader/writer (reader) 19c reads the figurine information on the set figurine 90.

Next, by proceeding to the subsequent Step 112, the CPU 32 determines whether or not chip reader/writer 19c succeeds in figurine information reading. Next, if the figurine information reading can be performed in a predetermined time, Step 113 is performed. In Step 113, the read flag is set to predetermined information (for example, “9”) and the figurine information reading receiving process ends. On the other hand, if there is no input of the figurine information in a predetermined time or if “no figurine” selection is performed with the touch panel 56, the figurine information reading receiving process ends without Step 113 preformed.

Returning to FIG. 26, by proceeding to Step 102 following Step 101, the CPU 32 determines whether or not the read flag is set to “9”. If the read flag is not set to “9”, by proceeding to Step 103, the figurine game process is performed, and if not, by proceeding to Step 104, the figurine game process is performed.

No Figurine Game Process

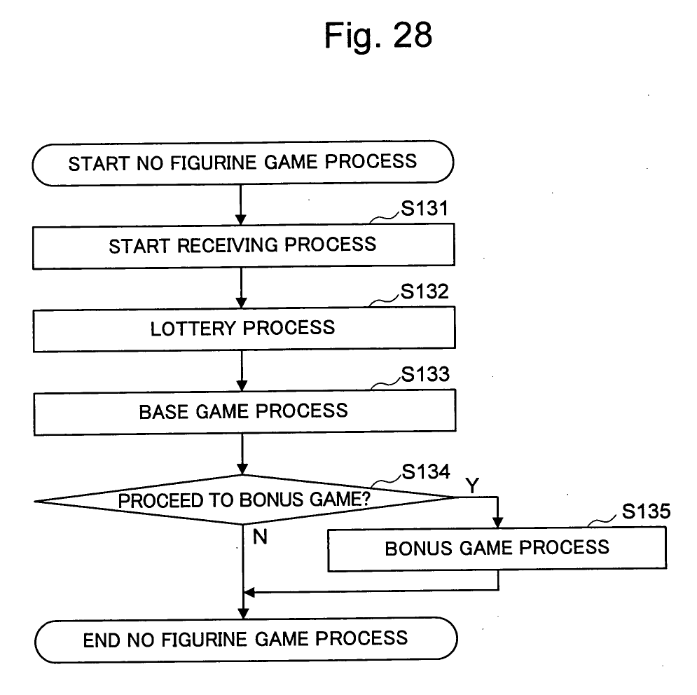

If the No figurine game process starts by proceeding from Step 102 to Step 103, the CPU 32 performs a sequence of processes shown in FIG. 28. That is, if the no figurine game process starts, a start receiving process is firstly performed as Step 131. By proceeding to the start receiving process, the slot machine 1F waits for a game starting manipulation from the gamer under the control of the CPU 32. Here, since the slot machine 1F is a coin inserting type-game machine, the game starting manipulation is a manipulation of pushing the spin switch 8 after inserting a predetermined number of coins into the coin insertion slot 6 or after pushing the 1-BET switch 9 or the maximum BET switch 10 in order to maintain a coin credit stored in the slot machine 1F. If the gamer pushes the spin switch 8, a start signal is transmitted from the spin switch 8 to the CPU 32, and the next process (Step 132) is performed.

Next, in Step 132, the CPU 32 operates as game mode controller and performs a lottery for transition into a bonus game by using a random number generated in cooperation with the aforementioned random number generator 35 and the sampling circuit 36. More specifically, a number among 120 numbers is defined as a number for transition into the bonus game, and if the random number matches with the number, the transition to the bonus game is determined. That is, the transition probability for the bonus game is defined as P0 (=1/120). Next, in Step 133 following the lottery process, a base game process for rotating the reels 3L, 3C, and 3R in a base game mode and then stopping the reels corresponding to a result of the lottery process is performed. In the base game process, if a marker besides the bonus game is awarded, coin payment is performed based on a dividend according to an award state, and then, Step 134 is performed.

By proceeding to Step 134, it is determined based on the result of the lottery process in Step 132 whether or not the transition into the bonus game is performed. Here, in a case in which the transition into the bonus game is determined by the lottery process, by proceeding to Step 135, the bonus game process is performed. In the other cases, the no figurine game process ends without the bonus game process performed.

In addition, if the bonus game process starts by proceeding to Step 135, the game mode becomes the bonus game mode, a plural-times (for example, three-times) free game is performed as the bonus game. In the free game, a game the same as the base game is performed without a new coin inserted, and coin payment is performed based on a dividend according to a combination of stopped designs. For this reason, in the bonus game mode, the gamer can acquire more coins than in the base game mode. In addition, if the three-times free game and the bonus game process end, the no figurine game process ends.

Figurine Game Process

In the slot machine 1F according to the present invention, in a case in which the gamer plays a game by using the figurine 90, there is provided two game states, that is, a standard game state in which a transition probability (a first transition probability in the present invention) from the base game mode into the bonus game mode is a standard transition probability and a high-probability game state in which a transition probability into the bonus game mode is higher than that of the standard game state.

By proceeding from Step 102 to Step 104, if the figurine game process starts, a game state transition condition from the standard game state to the high-probability game state is firstly set in Step 141. More specifically, a predetermined game time (predetermined slot game time in the present invention) during the transition of the game state from the standard game state to the high-probability game state and a high transition probability (a second transition probability in the present invention) in the high-probability game state are set. Next, the CPU 32 determines as the predetermined game time a time T1 (for example, 10 minutes) represented by the figurine time information included in the figurine information read from the figurine 90 by the IC chip reader/writer 19c and, similarly, determines as the high transition probability a probability P1 represented by the figurine probability information included in the figurine information.

Next, if the game state transition condition is set in Step 141, in the subsequent Step 142, the CPU 32 commands time counter 53 to start counting of the time, so that the counting of the game time by the time counter 53 starts.

Next, in the subsequent Step 143, the CPU 32 operates as probability changer and determines whether or not the game time counted in Step 142 reaches the predetermined game time T1 (that is, the time represented by the figurine time information). If the game time does not reach the predetermined game time T1, the standard game process (Step 144) for providing the gamer with a game in the standard game state is performed, and if the game time reaches the predetermined game time T1, the high-probability game process (Step 145) for providing the gamer with a game in the high-probability game state is performed.

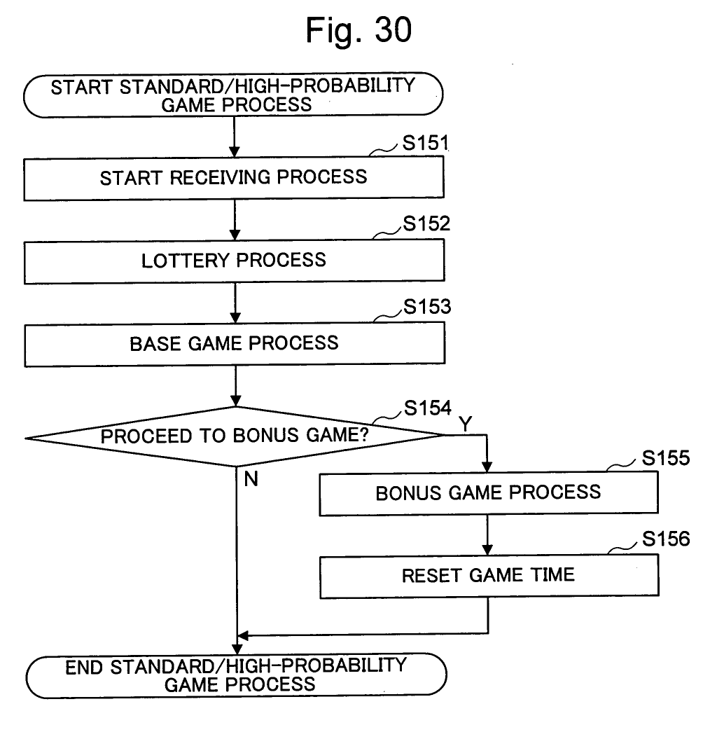

As shown in FIG. 30, the standard game process and the high-probability game process are equivalent to the aforementioned no figurine game process (see FIG. 28). That is, after a start receiving process the same as that of Step 131 is performed in Step 151, the CPU 32 operates as game mode controller and performs the lottery process the same as that of Step 132 in Step 152.

However, at the time of the lottery process in Step 152, the standard game process of Step 144 uses as the transition probability into the bonus game the standard transition probability P0 the same as that of the no figurine game process, and the high-probability game process of Step 145 uses as the transition probability into the bonus game the high transition probability P1 (=1/110) (the probability represented by the figurine probability information). In addition, as described above, since the probability P0 is 1/120, the probability P1 is higher than the probability P0.

Next, after a base game process the same as that of Step 133 is performed as Step 153 following the lottery process, by proceeding to Step 154, it is determined based on a result of the lottery process in Step 152 whether or not the transition into the bonus game is performed. Here, in a case in which the transition into the bonus game is determined by the lottery process, by proceeding to Step 155, the bonus game process is performed, and then, the standard game process or the high-probability game process ends. In the other cases, the standard game process or the high-probability game process ends without the bonus game process being performed.

In addition, in the standard game process and the high-probability game process, after the bonus game process (S155) ends, the CPU32 transmits a command for resetting the game time to the time counting circuit 53 (S156). By doing so, the time counting circuit 53 performs clearing of the game time, and then, starts counting of the game time again.

The processes from the game time determination process (S143) to the standard game process (S144) or the high-probability game process (S145) repeat until a process ending condition is satisfied. The determination of the process ending condition is performed in Step 147 following Step 146. In addition, the process ending condition is satisfied in a case in which the figurine sensor 19d senses that the gamer detaches the figurine 90 from the figurine mounting unit 19 or in a case in which the gamer inputs an ending command to the slot machine 1F by using the touch panel 56.

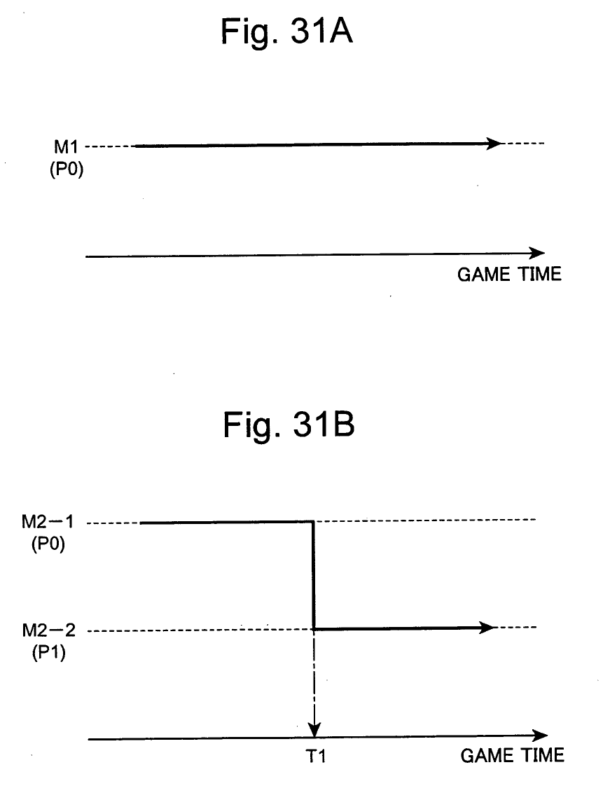

Now, a transition probability to the bonus game in the standard game state and the high-probability game state in the aforementioned no figurine and figurine game processes will be described with reference to FIG. 31A and FIG. 31B. In addition, FIG. 31A shows a timing chart in the no figurine game mode, and FIG. 31B shows a timing chart in the figurine game mode.

Firstly, as shown in FIG. 31A, in the no figurine game mode (M1), although the gamer starts the game and gradually increases the game time, the transition probability (P0) to the bonus game does not change. On the other hand, as shown in FIG. 31B, in the figurine game mode, at the time that a game time after the figurine game state starts or a game time after the ending of the previous bonus game reaches a predetermined time (that is, predetermined game time T1), the game state is transitioned from the standard game state (M2-1) to the high-probability game state (M2-2), and at the same time, the transition probability to the bonus game changes from the standard transition probability P0 to the high transition probability P1.

As described above in detail, in the slot machine 1F, when the gamer mounts the figurine 90 in the figurine mounting unit 19, the figurine information stored in the figurine 90 is read by the IC chip reader/writer 19c. If the reading of the figurine information is performed by the IC chip reader/writer 19c, in response to a command of the CPU 32, the time counter 53 starts counting of the game time. Next, if the game time reaches the predetermined game time T1, the CPU 32 operating as probability changer transitions the game mode from the standard game mode to the high-probability game mode, so that the transition probability can be changed from the standard transition probability P0 to the high transition probability P1 (>P0). Therefore, in the slot machine 1A, the gamer plays the game by using the figurine 90, so that the game can be played in a high transition probability from the base game mode to the bonus game mode.

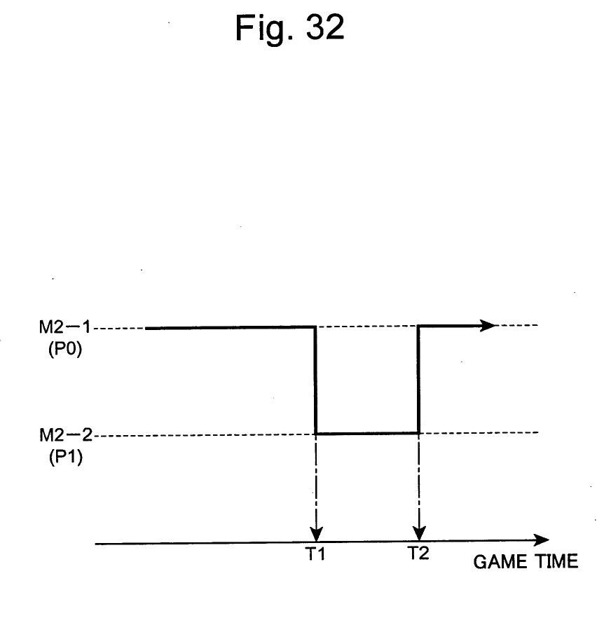

In addition, although an example in which the figurine information on the figurine 90 read by the IC chip reader/writer 19c includes only one figurine time information is described above, a plurality of the figurine time information may be included in the figurine information. In this case, one figurine time information properly selected may be used. In addition, two figurine time information may be used, and at the same time, the time T1 represented by the one figurine time information may be used as the aforementioned predetermined game time, and the time T2 (>T1) represented by the other figurine time information may be used to define an ended game time. In this case, as shown in FIG. 32, a process for returning the game mode from the high-probability game state (M2-2) in which the game time exceeds T1 to the standard game state (M2-1) in which the game time is T2 can be performed.

### Seventh Embodiment

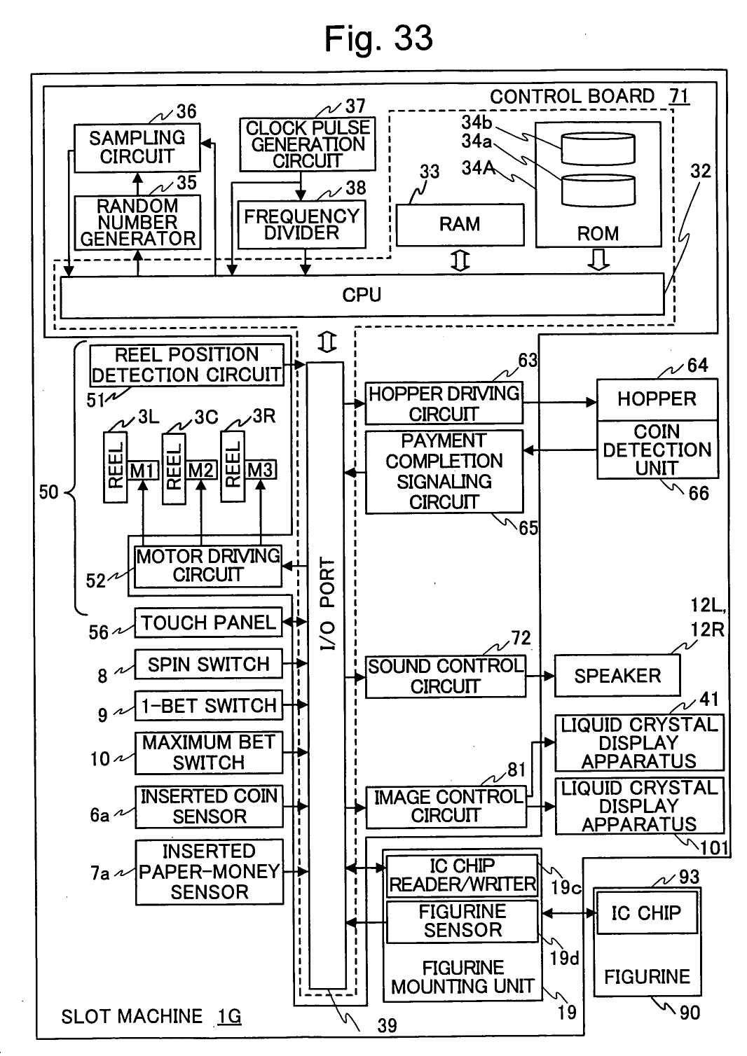

Now, a slot machine 1G according to a seventh embodiment will be described with reference to FIG. 33. Here, FIG. 33 is a block diagram mainly showing an internal construction of the slot machine 1G.

As shown in FIG. 33, the slot machine 1G is different from the slot machine 1F in that a game time database 34Aa and a transition probability database 34Ab are stored in a ROM 34A. In the game time database (number storage unit) 34Aa, information equivalent the aforementioned figurine time information, that is, information representing the game time T1 is stored. In addition, in the transition probability database (probability storage unit) 34Ab, information equivalent the aforementioned figurine probability information, that is, information representing the transition probability P1 is stored.

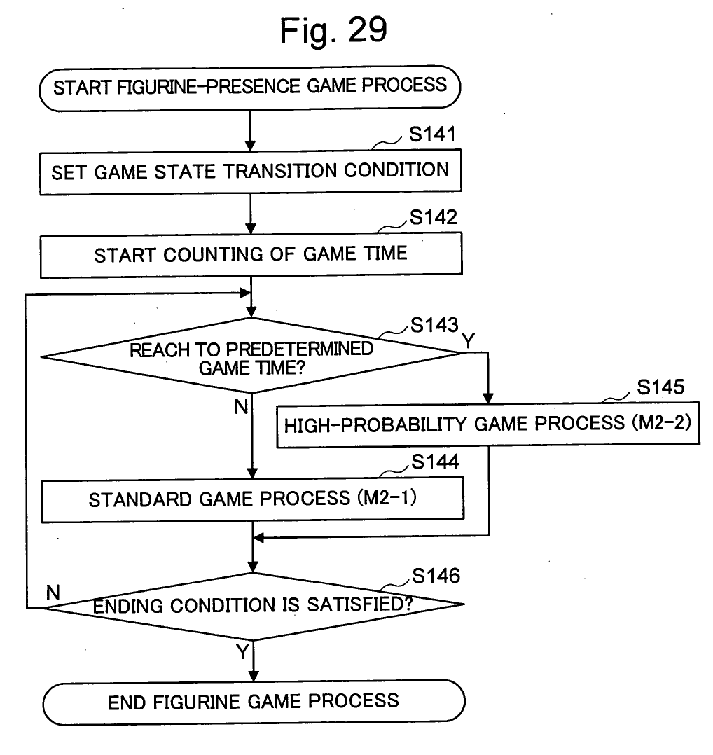

In addition, unlike the sixth embodiment, in the seventh embodiment, at the time of setting the game state transition condition of the figurine game mode (see S141 in FIG. 29), the CPU 32 determines the game time T1 stored in the game time database 34Aa as the predetermined game time and the probability P1 stored in the transition probability database 34Ab as the high transition probability.

In a case in which such processes are performed, the same effect as the aforementioned slot machine 1F can be obtained. In addition, similar to the sixth embodiment, a plurality of information may be suitably stored in the game time database 34Aa or the transition probability database 34Ab. That is, in this case, a process for selectively using one of the information representing the game time or a process for returning the high-probability game state (M2-2) in which the game time exceeds T1 to the standard game state (M2-1) in which the game time is T2 (>T1) may be performed, as shown in FIG. 32.

### Eighth Embodiment

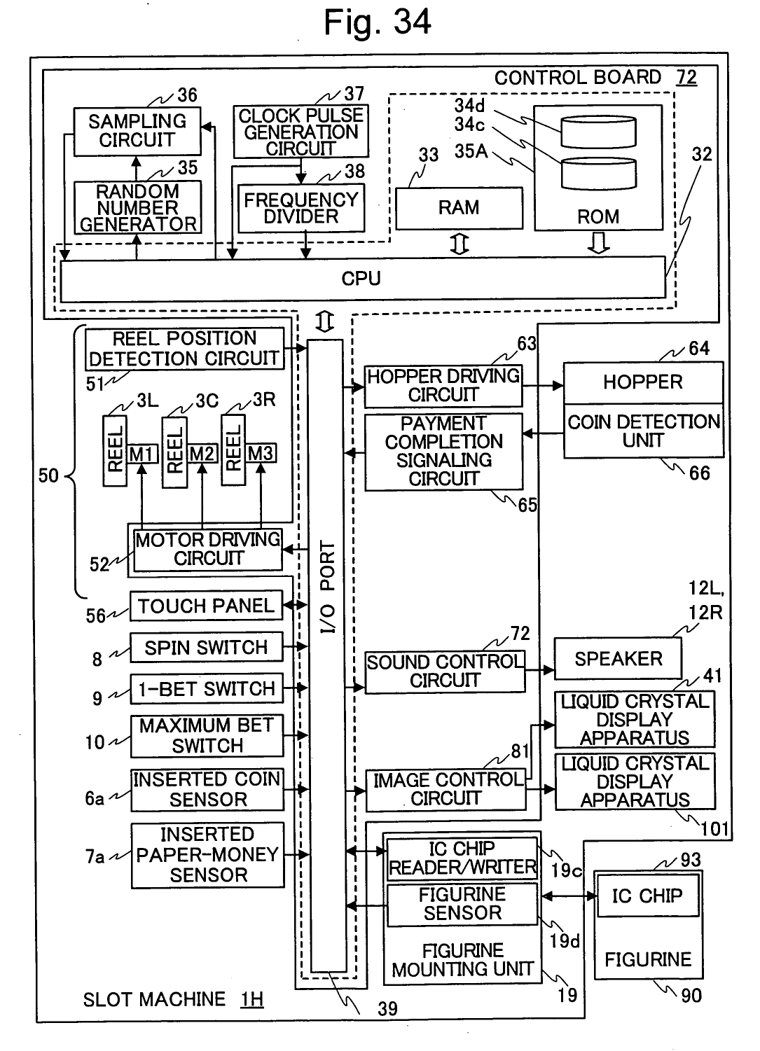

Now, a slot machine 1H according to an eighth embodiment will be described with reference to FIGS. 34 to 36. Here, FIG. 34 is a block diagram mainly showing an internal construction of the slot machine 1H.

Firstly, information on a figurine 90 used for the slot machine 1H will be described. In the embodiment, a figurine ID as the figurine information is stored in the figurine 90. The figurine ID is constructed with an alphabet and a 4-digit number. The alphabet indicates a type of figurine corresponding a three-dimensional shape of the figurine main body unit 92 (for example, “A”, “B”, and “C” indicating a wizard, a warrior, and common people, respectively), and the four-digit number indicates unique identification information for identifying the figurines (identifying oneself and others). That is, with respect to the figurine 90, the gamer can identify types of characters according to the three-dimensional shape of the figurine main body unit 92, and the slot machine 1H can identify the individual figurines according to the figurine IDs. In addition, in case of the figurine 90 shown in FIG. 9, the figurine ID is “B1001”, in which “B” is type and “1001” is identification information.

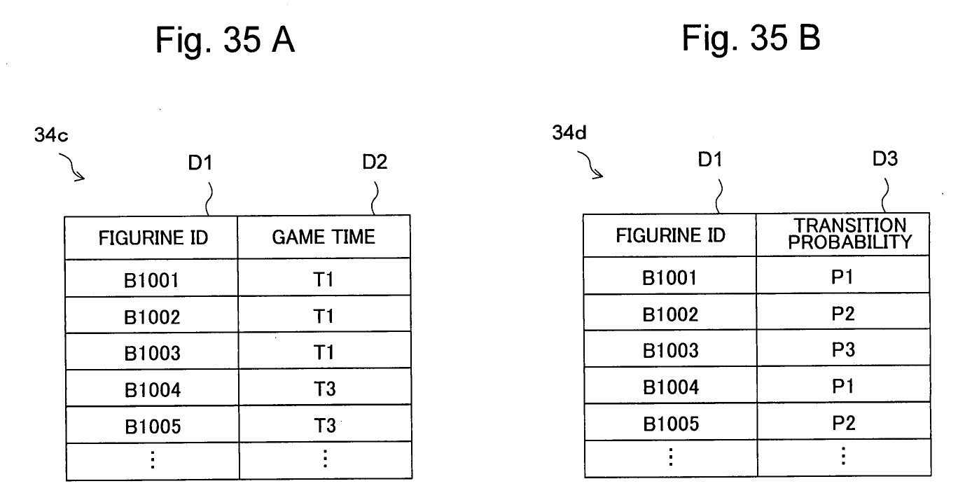

In addition, in the slot machine 1H, the figurine IDs and the game times and transition probabilities are stored in association with each other in the game time database 34Ac and the transition probability database 34Ad the same as those of the slot machine 1B. That is, in the game time database 34Ac, an item D1 in which a plurality of the figurine IDs are aligned and an item D2 in which the game times having the same number as that of the item D1 are aligned are stored in a one-to-one correspondence state (see FIG. 35A), and in the transition probability database 34Ad, an item D1 in which a plurality of the figurine IDs are aligned and an item D3 in which the transition probabilities having the same number as that of the item D1 are aligned are stored in one-to-one correspondence state (see FIG. 35B).

In addition, in the eighth embodiment, the figurine ID is read in Step 112 (see FIG. 27) of the aforementioned figurine information reading receiving process, and the figurine ID is temporarily stored in the RAM 33. Next, at the time of setting the game state transition condition of the figurine game mode (see Step 141 in FIG. 29), the. CPU 32 extracts the game time T1 stored in association with the corresponding figurine ID (B1001) in the game time database 34Ac by using the figurine ID stored in the RAM 33 as a search key and determines the extracted game time T1 as the predetermined game time. In addition, the CPU 32 extracts the transition probability P1 stored in association with the corresponding figurine ID (B1001) in the transition probability database 34Ad by using the figurine ID stored in the RAM 33 as a search key and determines the extracted transition probability P1 as the high transition probability.

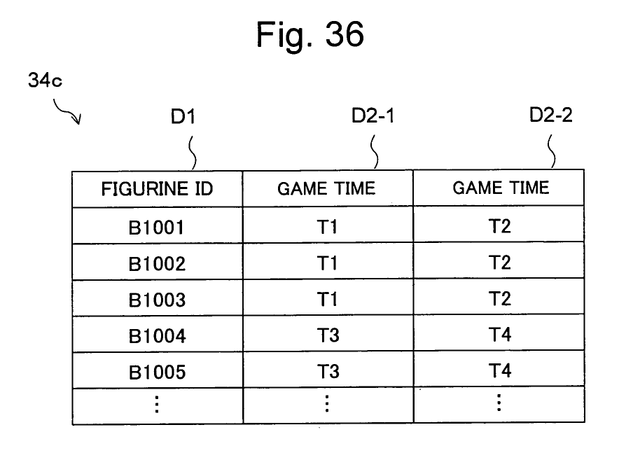

In a case in which such processes are performed, the same effect as the aforementioned slot machines 1F and 1G can be obtained. In addition, similar to the sixth and seventh embodiments, in the eighth embodiment, a process for returning the high-probability game state (M2-2) in which the game time exceeds T1 to the standard game state (M2-1) in which the game time is T2 (>T1) may be performed, as shown in FIG. 32. In this case, as shown in FIG. 36, in the game time database 34Ac, the item D1 for the figurine IDs and two items of the item D2-1 for the predetermined game times and the item D2-2 for the ending game times may be stored in association with each other.

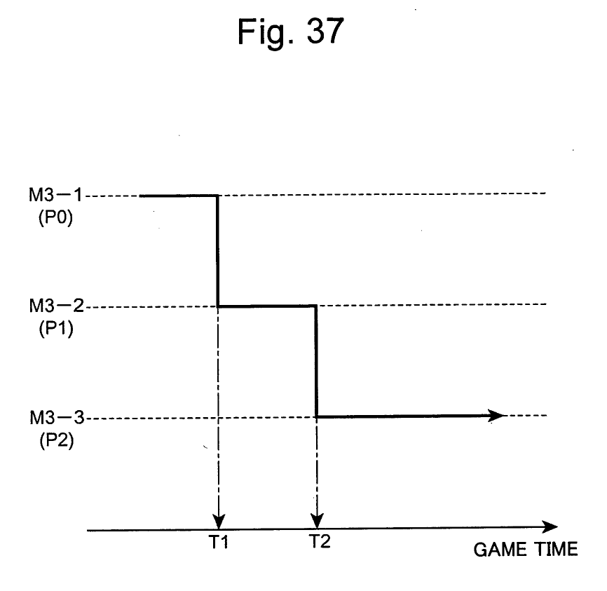

In addition, in the aforementioned sixth, seventh, and eighth embodiments, although two game modes (that is, the standard game mode and the high-probability game mode) having different transition probabilities to the bonus game in the figurine game mode are described, the number of game modes is not limited to two, but 3 or more may be suitably used. That is, as shown in FIG. 37, the CPU 32 may selectively determine the game mode based on the game time obtained by the time counter 53 by using a plurality of game time information T1 and T2 and a plurality of transition probability information P0, P1, and P2 stored in the slot machine 1F, 1G, or 1H or in the figurine 90.

### Ninth Embodiment

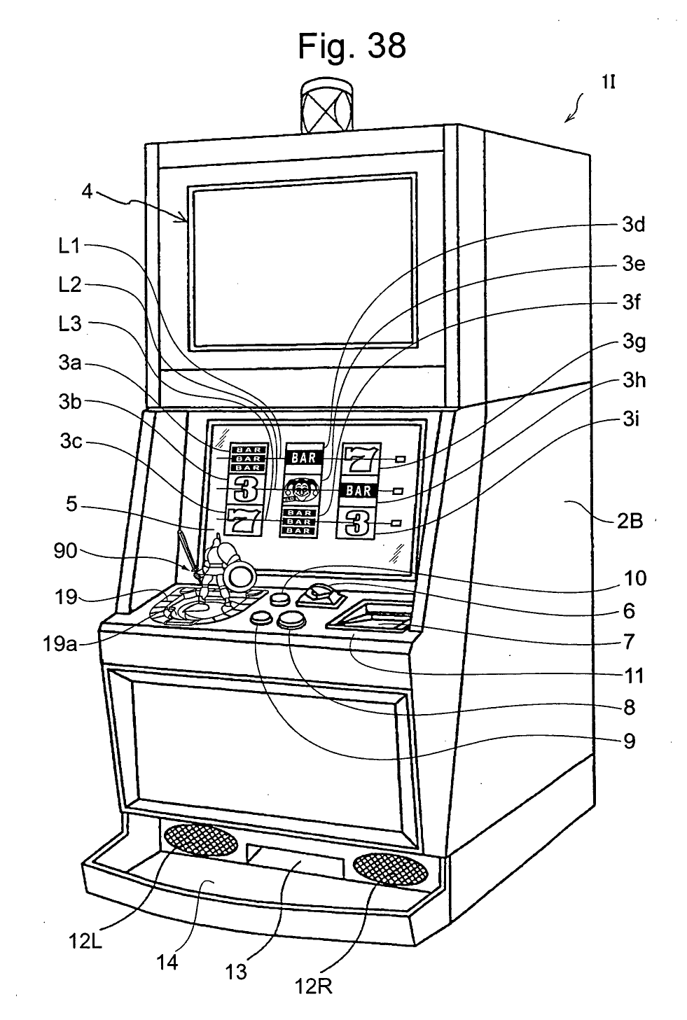

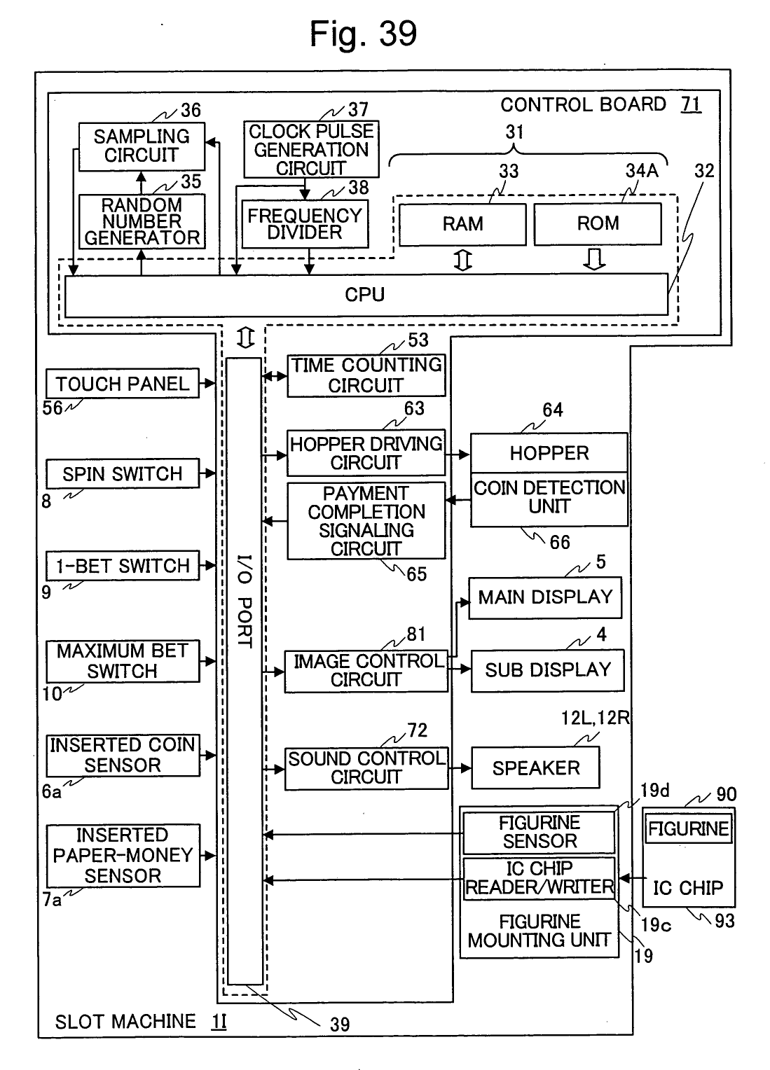

Now, a slot machine 1I according to a ninth embodiment will be described with reference to FIGS. 38 and 39. FIG. 38 is a perspective view showing an overall construction of the slot machine 1I according to the embodiment, and FIG. 39 is a block diagram mainly showing an internal construction thereof.

The slot machine 1I is a so-called video slot machine for displaying a changeable display image on a display, and the slot machine 1I is different from the aforementioned mechanical reel type slot machines 1F, 1G, and 1H in terms of the changeable display device and substantially equal thereto in terms of other components. More specifically, instead of the reels 3L, 3C, and 3R of the aforementioned slot machine 1F, 1G, and 1H, the slot machine 1I is constructed to have changeable display portions for displaying plural columns (three columns) displaying changeable display images of a plurality of designs and performs a changeable display image game (video slot game) by using the changeable display images displayed on the changeable display portions.

A main display 5 of the slot machine 1I has a total of nine changeable display portions 3a, 3b, 3c, 3d, 3e, 3f, 3g, 3h, and 3i aligned in horizontal and vertical three columns. In the base game mode and the bonus game mode, scroll display images (reel images displayed like the mechanical reels rotating) in which a plurality of the designs move downwards are displayed on the changeable display portions 3a to 3i of the main display 5. In addition, in FIG. 38, although vertical three columns of effective lines (L1 to L3) are provided, a total of eight effective lines (horizontal and vertical three columns of the changeable display portions 3a to 3i and two diagonal lines) may be provided.

Now, operational contents of the slot machine 1I will be described. Although a main process of the slot machine 1I is basically the same as that of the slot machine 1F, instead of rotating the reels 3L, 3C, and 3R, the slot machine 1I performs changeable display of the designs on the changeable display portions 3a to 3i in the base game mode and the bonus game mode. In addition, in the slot machine 1I, since the reels 3L, 3C, and 3R are not used, there is no limitation on the number of designs, and the transition probabilities can be changed by freely changing types of designs corresponding to the random numbers.

Such a slot machine 1I has operations and effects similar to or equivalent those of the slot machines 1F, 1G, and 1H.

### Tenth Embodiment

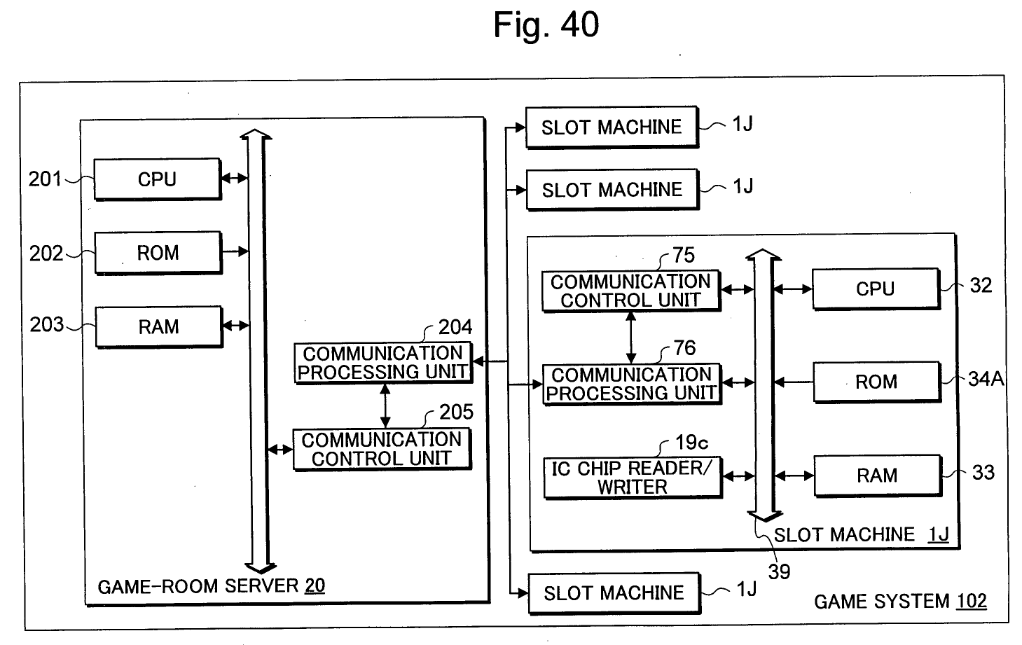

Now, an embodiment of a game system according to the present invention will be described. FIG. 40 is a block diagram showing a schematic construction of the game system according to the embodiment. The game system 100 includes a game-room server 20 installed in a game room and a plurality (four in the embodiment) of slot machines 1J communicationably connected to the game-room server 20, and a LAN is constructed in the game room by connecting the game-room server 20 and the slot machines 1J via a private line.

The game-room server 20 corresponds to a game server, and each of the slot machines 1J corresponds to a game machine, in the present invention. The slot machines 1J have constructions and functions similar to or equivalent the slot machines 1F to 1I according to the sixth to ninth embodiments.

The game-room server 20 includes a CPU 201, a ROM 202, a RAM 203, a communication processing unit 204, and a communication control unit 205, and although not shown, the aforementioned game time database 34Ac and transition probability database 34Ad are stored in the ROM (storage unit) 202.

The CPU 201 reads and writes data from and to the RAM 203 according to a program stored in the RAM 202, and in response to a command of the CPU 201, the communication control unit 205 drives the communication processing unit (receiver, transmitter) 204 to perform data reception and transmission from and to the slot machines 1J. In addition, the CPU 201 operates as information extractor to extract the game time information (for example, game time T1) and the transition probability information (for example, transition probability P1) from the ROM 202 based on figurine IDs transmitted from the slot machines 1J and transmits the information from the communication processing unit 204 to the slot machines 1J.

The slot machines 1J are different from the slot machine 1F, 1G, 1H, and 1I in terms of including a communication control unit 75 and a communication processing unit 76. The communication control unit 75 and the communication processing unit 76 are connected through an I/O port 39 to the CPU 32, and in response to a command of the CPU 32, the communication control unit 75 drives the communication processing unit (communication device) 76 to perform data reception and transmission from and to the game-room server 20.

Flow of information of the game system 100 having the aforementioned construction is similar to the flow of information in the aforementioned eighth embodiment. That is, in the slot machine 1H according to the eighth embodiment, the figurine IDs read from the figurine 90 are temporarily stored in the RAM 33, and at the time of setting the game state transition condition of the figurine game mode (see S141 in FIG. 29), the CPU 32 extracts the game time T1 stored in the game time database 34Ac and the transition probability P1 stored in the transition probability database 34Ad by using the figurine IDs stored in the RAM 33 as a search key. On the other hand, in the game system 100, although the figurine IDs read from the figurine 90 are temporarily stored in the RAM 33, but the game time T1 and the transition probability P1 are extracted from the game time database 34Ac and the transition probability database 34d stored in the ROM 202 of the game-room server 20 instead of the ROM 32 thereof. At the time of extraction, various data exchange is performed in cooperation with the communication processing unit 76 of the slot machines 1J and the communication processing unit 204 of the game-room server 20. That is, the figurine IDs read from the figurine 90 are transmitted from the slot machines 1J to the communication processing unit 204 of the game-room server 20, and on the contrary, the game time T1 and the transition probability P1 stored in the game time database 34Ac and the transition probability database 34d in association with the figurine IDs are transmitted from the game-room server 20 to the slot machines 1J.

Therefore, the game system 100 has operations and effects similar to or equivalent those of the slot machine 1H according to the eighth embodiment.

In the aforementioned embodiments, aspects in which a transition probability to the bonus game is changed due to the time output form the time counting circuit 53 are described. As described above, although the time counting circuit 53 is a component for starting counting of the time in response to a command of the CPU 32, effects the same as those of the aforementioned embodiment can be obtained by using a time output circuit for outputting time information on a current time instead of the time counting circuit 53. Now, embodiments using the time output circuit will be described.

### Eleventh Embodiment

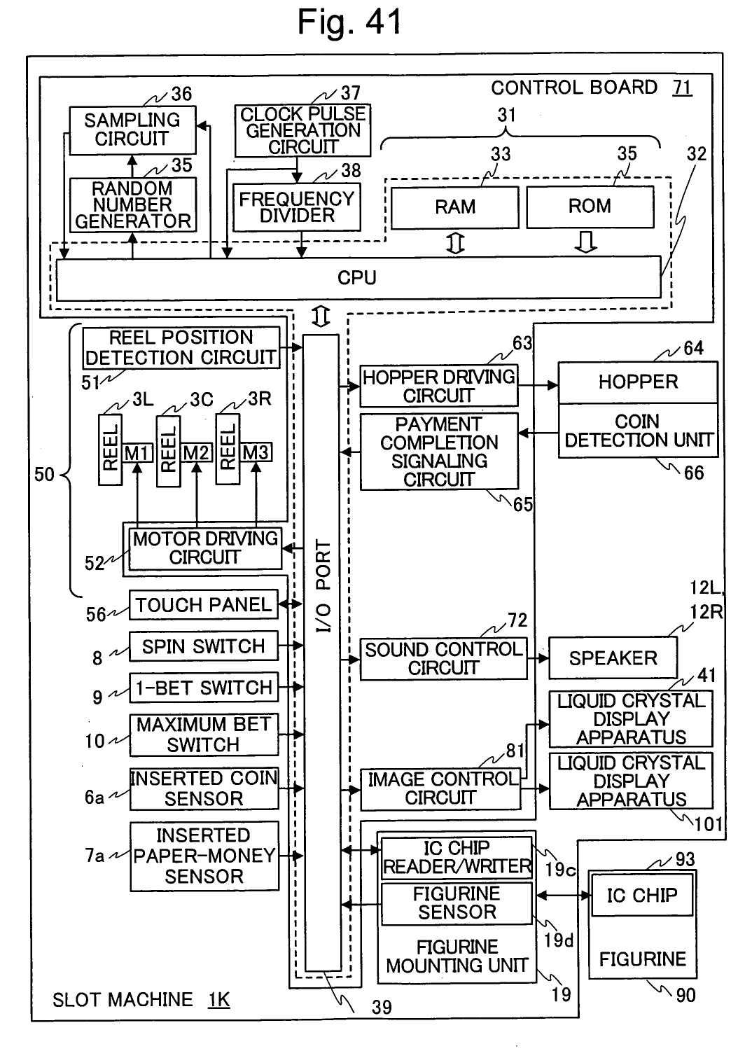

A slot machine 1K according to the embodiment is substantially equivalent the slot machine 1F according to the sixth embodiment and have the only different points in that the time counting circuit 53 of the slot machine 1F is replaced with the time output circuit 54 and in that information (specific time condition information and, hereinafter, referred to as figurine time condition information) on a condition about a time of transition from the standard game state to the high-probability game state is stored as figurine information in the figurine 90 instead of the information representing the game time, as shown in FIG. 41.

The time output circuit (time output means) 54 can output information (time information) on a current time (current time point) and performs an output process for the time information in response to a command of the CPU 32. That is, the CPU 32 can acquire the time information by using the time output circuit 54.

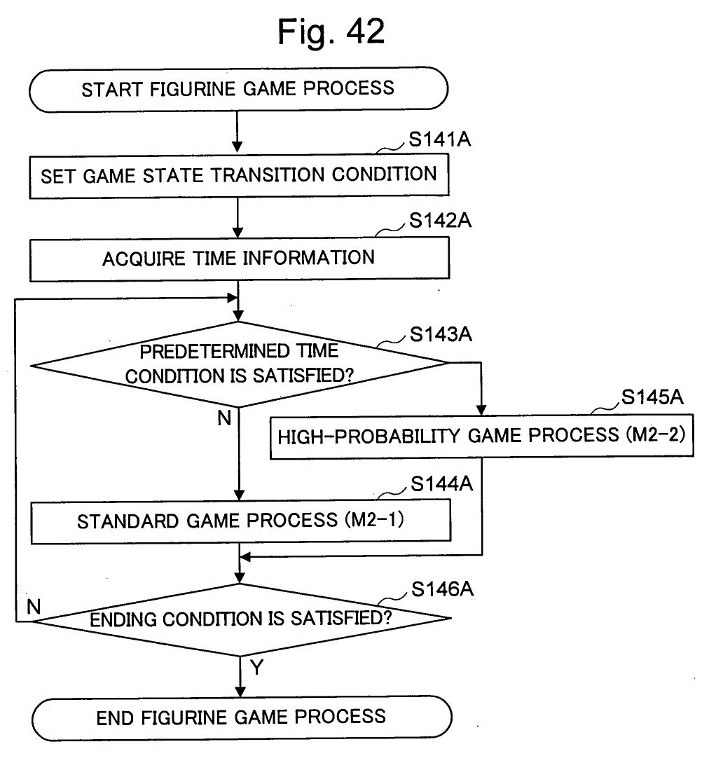

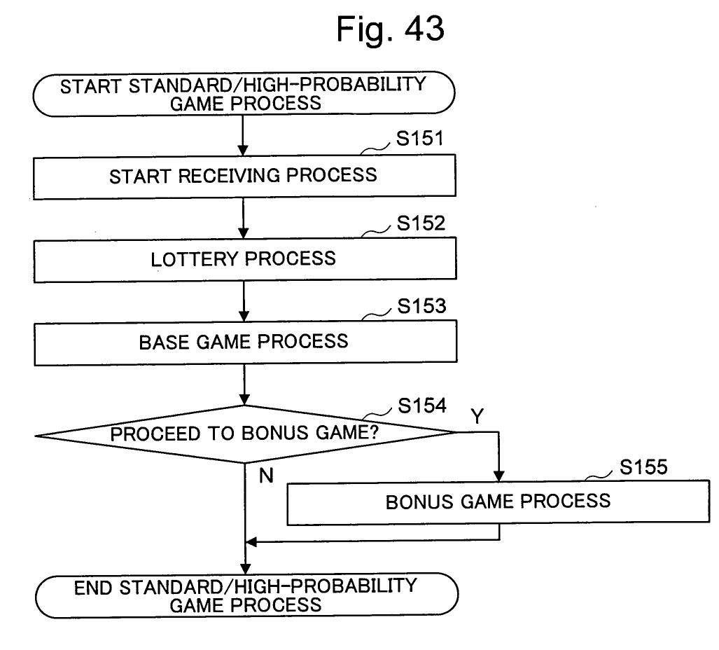

Similar to the slot machine 1F, in the slot machine 1K according to the embodiment, the CPU 32 operates as game playing controller and controls game playing in the base game mode and the bonus game mode. Now, examples of operations of the slot machine 1K will be described with reference to flowcharts shown in FIGS. 42 to 43. In addition, in FIGS. 42 to 43, “Step” is abbreviated to “S”.

The operations of the slot machine 1K are substantially equivalent those of the slot machine 1F, but different in terms of the figurine game process. For this reason, only the figurine game process of the slot machine 1K will be described.

As shown in FIG. 42, if the figurine game process starts, a game state transition condition from the standard game state to the high-probability game state is firstly set in Step 141A. More specifically, a predetermined time condition at the transition of the game state from the standard game state to the high-probability game state and a high transition probability (a second transition probability in the present invention) in the high-probability game state are set. Next, the CPU 32 determines as the predetermined time condition a time condition (for example, “after 11:00” or the like) represented by the figurine time condition included in the figurine information read from the figurine 90 by the IC chip reader/writer 19c and, similarly, determines as the high transition probability a probability P1 represented by the figurine probability information included in the figurine information.

Next, if the game state transition condition is set in Step 141A, in the subsequent Step 142A, the CPU 32 acquires the time information from the time output circuit 54. Next, in the subsequent Step 143A, the CPU 32 operates as probability changer and determines whether or not the time information acquired in Step 142A satisfies the predetermined time condition (that is, the time condition represented by the figurine time condition information). If the time information does not satisfy the predetermined time condition, the standard game process (Step 144A) for providing the gamer with a game in the standard game state is performed, and if the time information satisfies the predetermined time condition, the high-probability game process (Step 145A) for providing the gamer with a game in the high-probability game state is performed.

As shown in FIG. 43, the standard game process and the high-probability game process in the slot machine 1K are substantially equivalent to the aforementioned standard game process and the high-probability game process of the slot machine 1F (see FIG. 30). However, in the slot machine 1K, after the bonus game process (S155) ends, a process (S156) for resetting the game time is not required.

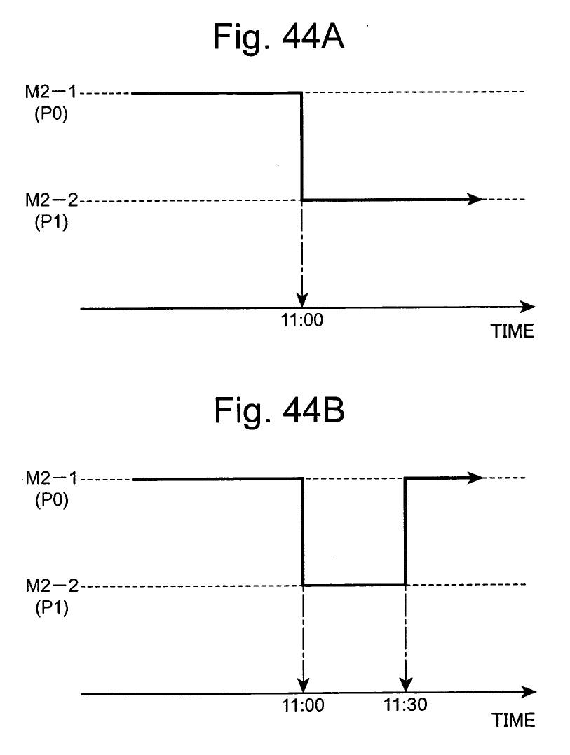

The transition probability to the bonus game in the figurine game process is shown in FIG. 44A. In addition, FIG. 44A shows a timing chart in the figurine game mode.. That is, in the figurine game mode, if the time satisfies the predetermined time condition (that is, at 11:00), the game state is transitioned from the standard game state (M2-1) to the high-probability game state (M2-2), and at the same time, the transition probability to the bonus game changes from the standard transition probability P0 to the high transition probability P1.

Therefore, in the slot machine 1K, when the gamer mounts the figurine 90 in the figurine mounting unit 19, the figurine information stored in the figurine 90 is read by the IC chip reader/writer 19c. At the time that the reading of the figurine information is performed by the IC chip reader/writer 19c, if the time represented by the time information acquired from the time output circuit 54 satisfies the predetermined time condition, the CPU 32 operating as probability changer transitions the game mode from the standard game mode to the high-probability game mode, so that the transition probability can be changed from the standard transition probability P0 to the high transition probability P1 (>P0). Therefore, similar to the slot machine 1F in the slot machine 1K, the gamer plays the game by using the figurine 90, so that the game can be played in a high transition probability from the base game mode to the bonus game mode.

In addition, although an example in which the figurine information on the figurine 90 read by the IC chip reader/writer 19c includes only one figurine time condition information is described above, a plurality of the figurine time condition information may be included in the figurine information. In this case, one figurine time condition information properly selected may be used. In addition, instead of the condition of “a time after 11:00”, a condition specifying starting and ending time points, for example, “a time between 11:00 and 11:30” may be used as the predetermined time condition (time condition represented by the figurine time condition information). In this case, at the time before 11:00 or after 11:30, since the predetermined time condition is not satisfied, a process for transitioning to the high-probability game mode (M2-2) at the starting time (11:00), and returning to the standard game mode (M2-1) at the ending time (11:30) can be performed, as shown in FIG. 44B.

### Twelfth Embodiment

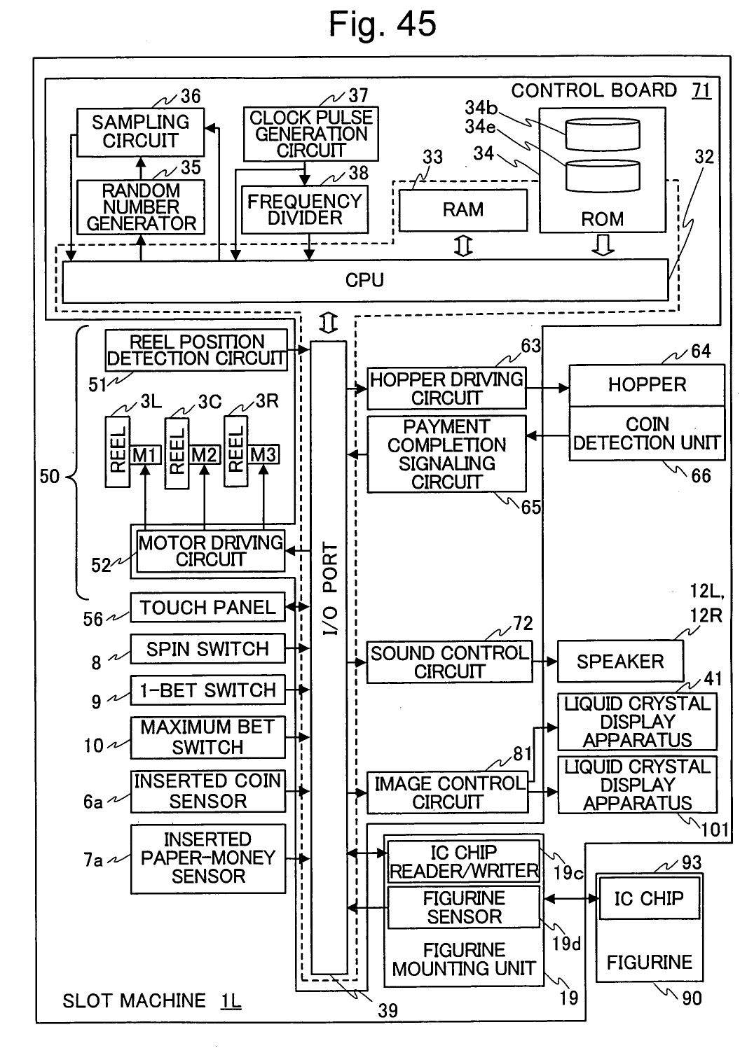

Now, a slot machine 1L according to a twelfth embodiment will be described with reference to FIG. 45. Here, FIG. 45 is a block diagram mainly showing an internal construction of the slot machine 1L.

As shown in FIG. 45, the slot machine 1L is different from the slot machine 1G according to the seventh embodiment in that the time output circuit 54 is provided instead of the time counting circuit 53 and in that a time condition database 34Ae is stored in the ROM 34A instead of the game time database 34Aa. In the time condition database (time condition storage unit) 34Ae, information equivalent the aforementioned figurine time condition information, that is, information representing the time condition after the transition to the bonus game mode is stored.

In addition, unlike the eleventh embodiment, in the twelfth embodiment, at the time of setting the game state transition condition of the figurine game mode (see S141A in FIG. 42), the CPU 32 determines the time condition represented by the time condition information stored in the time condition database 34Ae as the predetermined time condition and the probability P1 stored in the transition probability database 34Ab as the high transition probability.

In a case in which such processes are performed, the same effect as the aforementioned slot machine 1K can be obtained.

### Thirteenth Embodiment

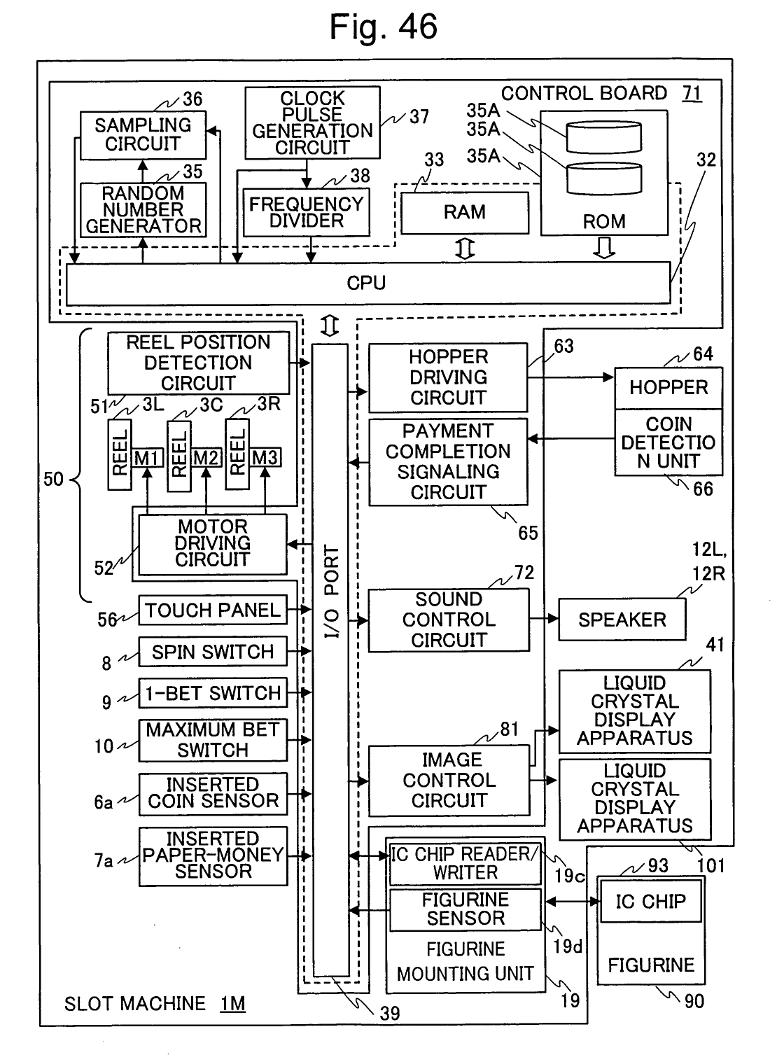

Now, a slot machine 1M according to a thirteenth embodiment will be described with reference to FIG. 46. Here, FIG. 34 is a block diagram mainly showing an internal construction of the slot machine NM.

As shown in FIG. 46, the slot machine 1M is different from the slot machine 1H according to the eighth embodiment in that the time output circuit 54 is provided instead of the time counting circuit 53 and in that a time condition database 34Af is stored in the ROM 34A instead of the game time database 34Ac.

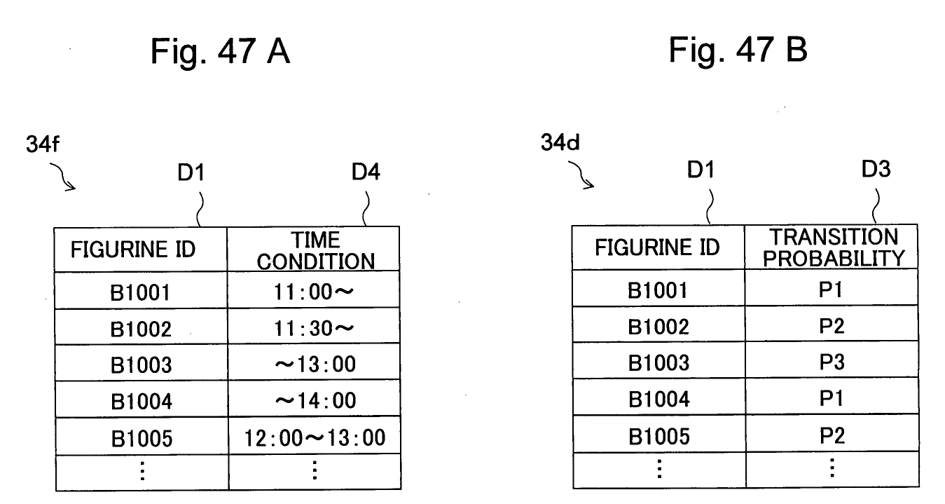

That is, in the slot machine 1M, a plurality of figurine IDs and the time conditions and transition probabilities are stored in association with each other in the time condition database 34Af and the transition probability database 34Ad. In other words, in the time condition database 34Af, an item D1 in which a plurality of the figurine IDs are aligned and an item D2 in which the time conditions having the same number as that of the item D1 are aligned are stored in one-to-one correspondence state (see FIG. 47A), and in the transition probability database 34Ad, an item D1 in which a plurality of the figurine IDs are aligned and an item D3 in which the transition probabilities having the same number as that of the item D1 are aligned are stored in one-to-one correspondence state (see FIG. 47B).

In addition, similar to the eighth embodiment, in the thirteenth embodiment, the figurine ID is read in Step 112 (see FIG. 27) of the aforementioned figurine information reading receiving process, and the figurine ID is temporarily stored in the RAM 33. Next, at the time of setting the game state transition condition of the figurine game mode (see Step 141A in FIG. 42), the CPU 32 extracts the time condition stored in association with the corresponding figurine ID (B1001) in the time condition database 34Af by using the figurine ID stored in the RAM 33 as a search key and determines the extracted time condition as the predetermined time condition. In addition, the CPU 32 extracts the transition probability P1 stored in association with the corresponding figurine ID (B1001) in the transition probability database 34Ad by using the figurine ID stored in the RAM 33 as a search key and determines the extracted transition probability P1 as the high transition probability.

In a case in which such processes are performed, the same effect as the aforementioned slot machines 1K and 1L can be obtained.

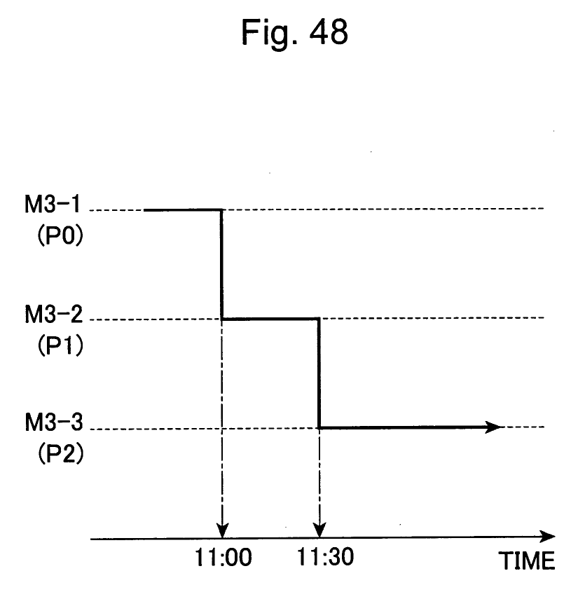

In addition, in the aforementioned eleventh, twelfth, and thirteenth embodiment, although two game modes (that is, the standard game mode and the high-probability game mode) having different transition probabilities to the bonus game in the figurine game mode are described, the number of game modes is not limited to two, and 3 or more may be suitably used (see FIG. 48). In FIG. 48, an aspect of the change in game states (M3-1→M3-2→M3-3) and the gradual change in transition probabilities (P0→P1→P2) are shown.

### Fourteenth Embodiment

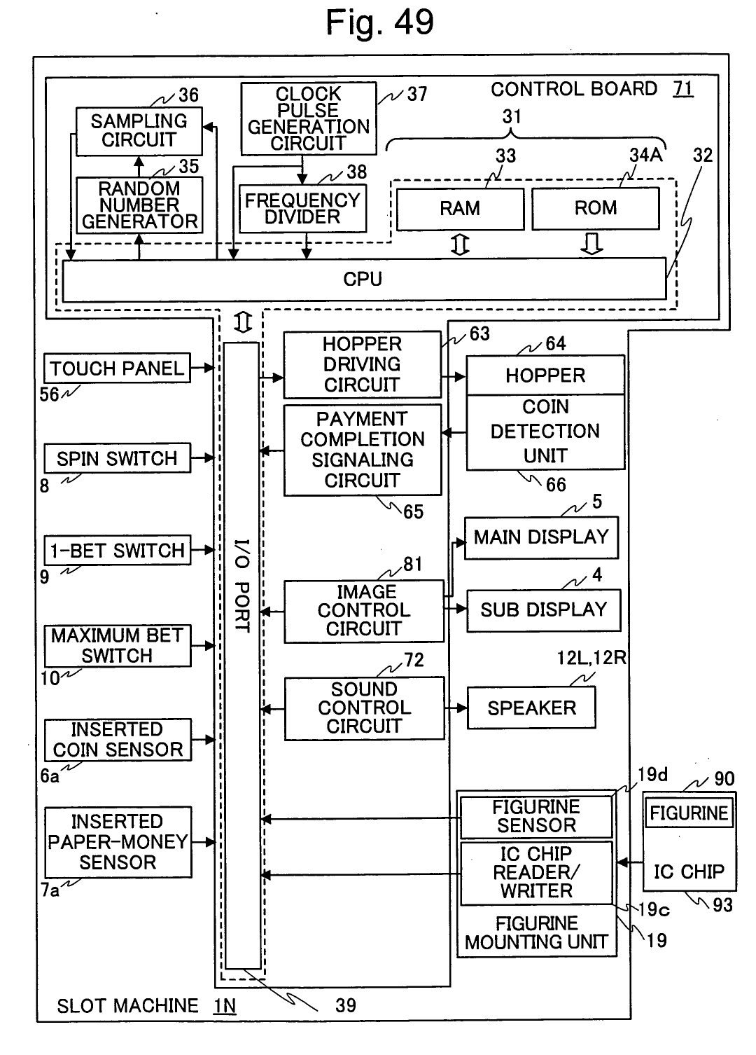

A slot machine 1N according to a fourteenth embodiment is a slot machine for performing a video slot game. In addition, as shown in FIG. 49, the slot machine 1N is different form the slot machine 1I according to the ninth embodiment in that the time output circuit 54 is provided instead of the time counting circuit 53. The operational contents of the slot machine 1N is basically the same as those of the slot machine 1K, and instead of rotating the reels 3L, 3C, and 3R, the slot machine 1N performs changeable display of designs on the changeable display portions 3a to 3i in the base game mode and the bonus game mode.

Therefore, such a slot machine 1N has operations and effects similar to or equivalent those of the slot machines 1K, 1L, and 1M.

### Fifteenth Embodiment

Now, an embodiment of a game system according to the present invention will be described. The game system 100 according to the embodiment includes a game-room server 20A installed in a game room and a plurality (four in the embodiment) of slot machines 1P communicationably connected to the game-room server 20A, and a LAN is constructed in the game room by connecting the game-room server 20A and the slot machines 1P via a private line. Here, the slot machines 1P have constructions and functions similar to or equivalent the slot machines 1K to 1N according to the aforementioned eleventh to fourteenth embodiments.

The game-room server 20A includes a CPU 201, a ROM 202, a RAM 203, a communication processing unit 204, and a communication control unit 205, and although not shown, the aforementioned time condition database 34Af and transition probability database 34Ad are stored in the ROM (storage unit) 202.

The CPU 201 reads and writes data from and to the RAM 203 according to a program stored in the RAM 202, and in response to a command of the CPU 201, the communication control unit 205 drives the communication processing unit (receiver, transmitter) 204 to perform data reception and transmission from and to the slot machines 1P. In addition, the CPU 201 operates as information extractor to extract the time condition time information and the transition probability information from the ROM 202 based on figurine IDs transmitted from the slot machines 1P and transmits the information from the communication processing unit 204 to the slot machines 1P.

The slot machines 1P are different from the slot machine 1K to 1N in terms of including a communication control unit 75 and a communication processing unit 76. The communication control unit 75 and the communication processing unit 76 are connected through an I/O port 39 to the CPU 32, and in response to a command of the CPU 32, the communication control unit 75 drives the communication processing unit (communication device) 76 to perform data reception and transmission from and to the game-room server 20.

Flow of information of the game system 100 having the aforementioned construction is similar to that of the aforementioned tenth embodiment, and different from that of the eighth embodiment in that, at the time of setting the game state transition condition of the figurine game mode (see S41A in FIG. 42), the CPU 32 extracts the time condition information and the transition probability P1 from the time condition database 34Af and the transition probability database 34Ad stored in the ROM 202 of the game-room server 20A instead of the ROM 34A thereof.

In addition, at the time of extraction, various data exchange is performed in cooperation with the communication processing unit 76 of the slot machines 1P and the communication processing unit 204 of the game-room server 20A. That is, the figurine IDs read from the figurine 90 are transmitted from the slot machines 1P to the communication processing unit 204 of the game-room server 20A, and on the contrary, the time condition and the transition probability P1 stored in the time condition database 34Af and the transition probability database 34d in association with the figurine IDs are transmitted from the game-room server 20A to the slot machines 1P.

Therefore, the game system 100 has operations and effects similar to or equivalent those of the slot machines 1K to 1N according to the eleventh to fourteenth embodiments.

The game machines and game systems according to the present invention have been described based on embodiments. However, the present invention is not limited to the aforementioned embodiments. For example, the number of reels is not limited to three, but five or nine reels, for example, may be employed. The present invention may also be applied to a game machine employing other apparatuses for displaying an image such as a display apparatus using an organic EL device instead of the liquid crystal display apparatuses 41 and 101. In addition, although slot machines are exemplified as the game machine in the embodiments, the present invention may be applied to a card game machine for playing a card game by displaying a card image representing trump cards or a mah-gong game machine for playing a mah-gong game.

In addition, the present invention may be applied to a game machine using money information stored in a prepaid card as information on a medium corresponding to a game medium.

In addition, the unit of output by the counting circuit is not limited to minutes, and hours and seconds may be properly employed. Moreover, the function of the counting circuit is able to execute by co-operation of the CPU and the clock pulse generation circuit and the frequency divider. Therefore, the time unit 40 (see FIG. 25) that is constructed by the CPU and the clock pulse generation circuit and the frequency divider is usable as the counter.

In addition, the game item is not limited to a figurine, and cards and cassettes may be employed. In addition, the aspect for storing the game associated information in the game item is not limited to a non-contact type data readable IC chip, but contact type data storage device may be employed. In addition, instead of data storage device such as a memory, by providing information display portions having an information storing function to the game item (for example, by attaching seals on which barcodes or two-dimensional codes are printed, directly performing printing, or performing carving), the game associated information may be stored in the game item. In addition, the two-dimensional codes are called two-dimensional barcodes 2, and for example, there is QR Code (a registered trademark of Denso Wave Incorporated). The two-dimensional codes can store a large amount of information in which data can be coded several ten times or several hundred times than that of the barcode. Like this, in case of providing the information display portions, a barcode reader or the like is provided as reader instead of the aforementioned IC chip reader/writer.

What is claimed is:

1. A game machine having a base game mode and a bonus game mode as game modes, comprising:
game mode controller for transitioning the game mode from base game mode into the bonus game mode by using a first transition probability which is a transition probability from the base game mode into the bonus game mode;
reader for reading game associated information from a game item storing the game associated information on the game;
counter for starting counting of a game number if the game associated information is read by the reader; and
probability changer for changing the first transition probability used in the game mode controller to a second transition probability which is higher than the first transition probability, if the game number counted by the counter reaches the predetermined game number.

2. The game machine according to claim 1,
wherein the game associated information stored in the game item comprises bonus game number information representing a game number for changing from the first transition probability to the second transition probability, and
wherein the probability changer uses the game number represented by the bonus game number information included in the game associated information read by the reader as the predetermined game number at the time of changing from the first transition probability to the second transition probability.

3. The game machine according to claim 1, further comprising a number storage unit for storing game number information,
wherein the probability changer uses the number represented by the game number information stored in the number storage unit as the predetermined game number at the time of changing from the first transition probability to the second transition probability.

4. The game machine according to claim 3,
wherein the number storage unit stores a plurality of the game number information and the game associated information on the game in association with each other, and
wherein the probability changer uses a game number represented by the game number information stored in the number storage unit in association with the game associated information read by the reader as the predetermined game number at the time of changing from the first transition probability to the second transition probability.

5. The game machine according to claim 1,
wherein the game associated information stored in the game item includes specific probability information representing a transition probability to the first transition probability, and
wherein the probability changer uses a probability represented by the specific probability information included in the game associated information read by the reader as the second transition probability.

6. The game machine according to claim 1, further comprising a probability storage unit storing a plurality of different probability information,
wherein the game mode controller uses a probability represented by one of the plurality of probability information stored in the probability storage unit as the first transition probability, and
wherein the probability changer uses a probability represented by one of the plurality of probability information stored in the probability storage unit as the second transition probability.

7. The game machine according to claim 6,
wherein the probability storage unit stores the probability information and the game associated information on the game in association with each other, and
wherein the probability changer uses a probability represented by the probability information stored in the probability storage unit associated with the game associated information read by the reader as the second transition probability.

8. A game system having a game machine having a base game mode and a bonus game mode as game modes and a game server communicationably connected to the game machine,
wherein the game machine comprises:
game mode controller for transitioning the game mode from base game mode into the bonus game mode by using a first transition probability which is a transition probability from the base game mode into the bonus game mode;
reader for reading game associated information from a game item storing the game associated information on the game;
communication device for transmitting the game associated information read by the reader to the game server and receiving game number information transmitted from the game server, if the game associated information is read by the reader;
counter for starting counting of a game number if the game associated information is read by the reader; and
probability changer for changing the first transition probability used in the game mode controller to a second transition probability which is higher than the first transition probability, if the game number counted by the counter reaches the predetermined game number represented by the game number information received by the communication device, and
wherein the game server comprises:
a storage unit for storing the game associated information on the game item and the game number information in association with each other;
receiver for receiving the game associated information transmitted from the game machine;
information extractor for extracting the game number information stored in the storage unit in association with the game associated information received by the receiver; and
transmitter for transmitting the game number information extracted by the information extractor to the game machine.

9. A game machine having a base game mode and a bonus game mode as game modes, comprising:
game mode controller for transitioning the game mode from base game mode into the bonus game mode by using a first transition probability which is a transition probability from the base game mode into the bonus game mode;
reader for reading game associated information from a game item storing the game associated information on the game;
time counter for starting counting of a game time if the game associated information is read by the reader; and
probability changer for changing the first transition probability used in the game mode controller to a second transition probability which is higher than the first transition probability, if the game time counted by the time counter reaches the predetermined time.

10. The game machine according to claim 9,
wherein the game associated information stored in the game item includes bonus game time information representing a game time for changing from the first transition probability to the second transition probability, and
wherein the probability changer uses the game time represented by the bonus game time information included in the game associated information read by the reader as the predetermined time at the time of changing from the first transition probability to the second transition probability.

11. The game machine according to claim 9, further comprising a time storage unit for storing game time information,
wherein the probability changer uses the time represented by the game time information stored in the time storage unit as the predetermined time at the time of changing from the first transition probability to the second transition probability.

12. The game machine according to claim 11,
wherein the time storage unit stores a plurality of the game time information and the game associated information on the game in association with each other, and
wherein the probability changer uses a game time represented by the game time information stored in the time storage unit in association with the game associated information read by the reader as the predetermined time at the time of changing from the first transition probability to the second transition probability.

13. A game machine having a base game mode and a bonus game mode as game modes, comprising:
game mode controller for transitioning the game mode from base game mode into the bonus game mode by using a first transition probability which is a transition probability from the base game mode into the bonus game mode;
reader for reading game associated information from a game item storing the game associated information on the game;
time output device for outputting information on a current time; and
probability changer for changing the first transition probability used in the game mode controller to a second transition probability which is higher than the first transition probability, if a time represented by the time information output by the time output device as the time that the game associated information is read by the reader satisfies a predetermined time condition.

14. The game machine according to claim 13,
wherein the game associated information stored in the game item includes bonus game time information representing a time condition for changing from the first transition probability to the second transition probability, and
wherein the probability changer uses the time condition represented by the bonus game time information included in the game associated information read by the reader as the predetermined time condition at the time of changing from the first transition probability to the second transition probability.

15. The game machine according to claim 13, further comprising a time condition storage unit for storing time condition information,
wherein the probability changer uses the time condition represented by the time condition information stored in the time condition storage unit as the predetermined time condition at the time of changing from the first transition probability to the second transition probability.

16. The game machine according to claim 15,
wherein the time condition storage unit stores a plurality of the time condition information and the game associated information on the game in association with each other, and
wherein the probability changer uses a time condition represented by the time condition information stored in the time condition storage unit in association with the game associated information read by the reader as the predetermined time condition at the time of changing from the first transition probability to the second transition probability.

17. The game machine according to claim 9,
wherein the game associated information stored in the game item includes specific probability information representing a transition probability to the first transition probability, and
wherein the probability changer uses a probability represented by the specific probability information included in the game associated information read by the reader as the second transition probability.

18. The game machine according to claim 9, further comprising a probability storage unit storing a plurality of different probability information,
wherein the game mode controller uses a probability represented by one of the plurality of probability information stored in the probability storage unit as the first transition probability, and
wherein the probability changer uses a probability represented by one of the plurality of probability information stored in the probability storage unit as the second transition probability.

19. The game machine according to claim 18,
wherein the probability storage unit stores the probability information and the game associated information on the game in association with each other, and
wherein the probability changer uses a probability represented by the probability information stored in the probability storage unit associated with the game associated information read by the reader as the second transition probability.

20. A game system having a game machine having a base game mode and a bonus game mode as game modes and a game server communicationably connected to the game machine,
wherein the game machine comprises:
game mode controller for transitioning the game mode from base game mode into the bonus game mode by using a first transition probability which is a transition probability from the base game mode into the bonus game mode;
reader for reading game associated information from a game item storing the game associated information on the game;
communication device for transmitting the game associated information read by the reader to the game server and receiving game time information transmitted from the game server, if the game associated information is read by the reader;
time counter for counting a game time if the game associated information is read by the reader; and
probability changer for changing the first transition probability used in the game mode controller to a second transition probability which is higher than the first transition probability, if the game time reaches a predetermined time represented by the game time information received by the communication device, and
wherein the game server comprises:
a storage unit for storing the game associated information on the game item and the game time information in association with each other;
receiver for receiving the game associated information transmitted from the game machine;
information extractor for extracting the game time information stored in the storage unit in association with the game associated information received by the receiver; and
transmitter for transmitting the game time information extracted by the information extractor to the game machine.

21. A game system having a game machine having a base game mode and a bonus game mode as game modes and a game server communicationably connected to the game machine,
wherein the game machine comprises:
game mode controller for transitioning the game mode from base game mode into the bonus game mode by using a first transition probability which is a transition probability from the base game mode into the bonus game mode;
reader for reading game associated information from a game item storing the game associated information on the game;
communication device for transmitting the game associated information read by the reader to the game server and receiving time condition information transmitted from the game server, if the game associated information is read by the reader;
time output device for outputting information on a current time; and
probability changer for changing the first transition probability used in the game mode controller to a second transition probability which is higher than the first transition probability, if a time represented by the time information output by the time output device as the time that the game associated information is read by the reader satisfies a predetermined time condition represented by the time condition information received by the communication device, and
wherein the game server comprises:
a storage unit for storing the game associated information on the game item and the time condition information in association with each other;
receiver for receiving the game associated information transmitted from the game machine;
information extractor for extracting the time condition information stored in the storage unit in association with the game associated information received by the receiver; and
transmitter for transmitting the time condition information extracted by the information extractor to the game machine.
